(19) United States
(12) Patent Application Publication
(10) Pub. No.: US 2025/0324388 A1
(43) Pub. Date: Oct. 16, 2025

(54) OPEN PNT ACCESS TO CELLULAR NETWORK SUPPORTING ACCURATE AND RESILIENT PNT SERVICES

(71) Applicant: NextNav, LLC, Sunnyvale, CA (US)

(72) Inventors: Mariam SOROND, Vienna, VA (US); John Yongchae KIM, Centreville, VA (US); Julio ARMENTA, Aldie, VA (US); Kang-Che HSU, Woodinville, WA (US); Rabih CHRABIEH, Montrouge (FR); Apostolos PAPATHANASIOU, San Jose, CA (US)

(21) Appl. No.: 19/178,813

(22) Filed: Apr. 14, 2025

Related U.S. Application Data
(60) Provisional application No. 63/633,950, filed on Apr. 15, 2024.

(51) Int. Cl. H04W 64/00; H04L 5/00; H04W 8/22; H04W 12/06; H04W 60/04

(52) U.S. Cl. CPC H04W 64/00; H04L 5/0051; H04W 8/22; H04W 12/06; H04W 60/04

(57) ABSTRACT

Techniques for open position, navigation, and timing (PNT) access to cellular network supporting accurate and resilient PNT services are described herein. A user equipment (UE) registered to a network configured to provide positioning services may receive the positioning services from the network. Another UE registered to a different network not configured to provide positioning services may also receive the positioning services from the network configured to provide positioning services based on a centralized platform operable to facilitate operations associated with both networks.

### CROSS-REFERENCE TO RELATED APPLICATIONS

This application claims the benefit of U.S. Provisional Application No. 63/633,950, filed Apr. 15, 2024, the content of which is herein incorporated by reference in its entirety for all purposes.

### FIELD

This disclosure relates to wireless communication network capabilities.

### BACKGROUND

Cellular network signals have been used in the past for estimating the position and timing of user equipment. Various methods have been used to determine position or extract timing information from cellular signals including the use of cellular signal strength and time-of-arrival based methods on reference/pilot signals. Dedicated positioning signals such as positioning reference signals (PRSs) have been incorporated into cellular standards such as long-term evolution (LTE) and fifth generation (5G) new radio (NR). However, using these dedicated positioning signals to determine accurate position and time is challenging while maintaining the primary purpose (e.g., voice and data capacity) of the cellular network. Another challenge is to obtain this performance in a resilient manner including reliability metrics such as integrity, continuity, and availability. The accuracy and reliability of position and time estimation are critical, especially in applications like navigation, emergency services, and location-based services, as well as in critical infrastructure applications.

### BRIEF DESCRIPTION OF THE DRAWING

FIG. 1 illustrates an example of a network in accordance with one or more implementations described herein.

FIGS. 2A and 2B illustrate examples of a network in accordance with one or more implementations described herein.

FIG. 3 illustrates an example of a signaling diagram in accordance with one or more implementations described herein.

FIG. 4 illustrates an example of a resource timeline in accordance with one or more implementations described herein.

FIG. 5 illustrates an example of a signaling diagram in accordance with one or more implementations described herein.

FIG. 6 illustrates an example of a network that supports open position, navigation, and timing (PNT) in accordance with one or more implementations described herein.

FIG. 7 illustrates an example of an environment that supports open PNT in accordance with one or more implementations described herein.

FIG. 8 illustrates an example of a process that supports open PNT in accordance with one or more implementations described herein.

FIG. 9 illustrates an example of a process that supports open PNT in accordance with one or more implementations described herein.

FIG. 10 illustrates an example of a device diagram in accordance with one or more implementations described herein.

FIG. 11 illustrates an example of a process that supports open PNT access to a cellular network supporting accurate and resilient PNT services in accordance with one or more implementations described herein.

FIG. 12 illustrates an example of a process that supports open PNT access to a cellular network supporting accurate and resilient PNT services in accordance with one or more implementations described herein.

### DETAILED DESCRIPTION

Determining accurate location or timing from cellular signals (e.g., positioning reference signals (PRSs)) poses various challenges, including fine synchronization between transmissions from network entities (e.g., base stations, transmission reception points (TRPs)), which may not be required for wireless communication (e.g., cellular voice/data) services. In some cases, for a resilient positioning, navigation, and timing (PNT) in the context of synchronization, the synchronization may be fine and resilient (e.g., resilient to outages from global positioning system (GPS)). In some cases, such as for timing applications, the PRSs may provide an indication of coordinated universal time (UTC) and, in some cases, have verifiable traceability to UTC. While cellular signals, being terrestrial, may be more resilient than satellite signals (e.g. from GPS and LEO (Low Earth Orbit) to jamming and spoofing due to higher signal strengths, additional mechanisms may be included in the cellular system. Terrestrial systems also have a fundamental near-far problem for multilateration which is generally overcome using a combination of interference reduction techniques based on concepts from multiple access schemes such as time division multiple access (TDMA), code-division multiple access (CDMA), and frequency division multiple access (FDMA). Such techniques are included in dedicated positioning signals in cellular systems, such as PRS, but the choice of configurations of these signals at a PNT network level to enable high-quality PNT may need special attention. One other consideration is to implement these techniques while re-using the existing ecosystem of network entities (e.g., base stations, TRPs) and user equipment (UE) as much as possible.

Dedicated wide-area terrestrial systems (e.g., NextNav LLC's TERRAPOINT or Terrestrial Beacon System (TBS), as disclosed in ATIS contribution “ESIF-ESM-2015-0038R001 MBS-ICD”) for PNT purposes have overcome some of the above challenges through a variety of techniques. The proposed system disclosed herein translates accurate and resilient PNT techniques from such a dedicated system into a cellular system and combines with the capabilities of a cellular system to create a high-accuracy PNT solution that may be used for a variety of applications.

Determining an accurate location of a UE, such as a mobile device (e.g., a phone, laptop computer, tablet, or another device), in an environment may be quite challenging, especially when the UE is located in an urban environment or is located within a building. Multilateration involves solving a set of mathematical equations derived from the distances between the UE and each of the known transmit points. These distances are typically calculated based on the time of arrival (TOA), time difference of arrival (TDOA), or received signal strength (RSS) of the signals (for example, reference signals in a cellular system) emitted by transmitters. In some applications, imprecise estimates of the UE's position may have significant consequences for the corresponding user. For example, an imprecise position estimate of a UE, such as a mobile phone operated by a user calling emergency services, may delay emergency personnel response times. In less dire situations, imprecise estimates of the UE's position may negatively impact navigation applications by directing a user to the wrong location or taking too long to provide accurate directions. Various signal processing techniques are developed for estimating accurate time of arrival as well as for multilateration for the dedicated PRSs. In addition, given the connectivity available to the UE through a cellular network, various additional techniques using assistance information (e.g. indoor/outdoor maps, signal quality information) may be used to further improve performance.

While such a cellular system may operate using the positioning signals (e.g., PRSs) on the downlink (DL) (e.g. using DL-TDOA measurements) and has the advantage of unlimited user capability, since the users only need to listen to the dedicated positioning signals, the availability of uplink (UL) capability may be taken advantage of in certain positioning use cases as well. For example, positioning signals in the UL (e.g., sounding reference signals (SRS) in LTE and/or 5G), could be used to compute round-trip timing with multiple network entities enabling position computation using these round-trip-measurements without fine synchronization of the transmitters. Another application could be the use of these UL signals in a tightly synchronized network to enable the computation of ranges and positions on the network (e.g., using UL-TDOA).

Such a cellular PNT system may be frequency agnostic (e.g., may operate in any available frequency band within a variety of bandwidths). There are significant indoor penetration advantages that make systems that operate close to a carrier frequency of 1 GHz efficient and cost-effective for a combination of cellular and PNT purposes. One such band is the 902-928 MHz band. The cellular PNT network including PRSs could operate, for example, in frequency division duplex (FDD) mode, time division duplex (TDD) mode, or in a downlink-only mode in a standalone or carrier aggregation with another FDD or TDD cellular network band.

As is known in the art, an access network refers to the entirety of the infrastructure that connects end-users to their nearest telecommunications provider. Such access networks may be cellular networks (e.g., 5G) that provide 3GPP positioning related features.

In some embodiments, PNT services of the baseline cellular access network are made to be more accurate and/or resilient with enhanced features of a terrestrial PNT network, such as two-way time transfer techniques (TWTT), one-way-time transfer techniques (OWTT) and fine synchronization up to the antenna in order to provide accurate and resilient PNT services, thereby realizing the Cell-PNT network disclosed herein.

In one embodiment, the Cell-PNT network may utilize Fifth Generation New Radio (5G NR) signals to transmit positioning reference signal (PRS) on the downlink for position estimation of the UE or to determine time (e.g., UTC) at a known position of the UE based on the time of transmission of the PRS.

In some embodiments, the access network also provides network connectivity to auxiliary distributed sensor systems (e.g., altitude determination reference stations of the terrestrial PNT network) used for PNT assistance enhanced features.

Additionally, although in some scenarios PNT is the core mission of the Cell-PNT network, it does not consume all of the data exchange capacity of the network. In some scenarios, PNT service overhead requiring data exchange within the Cell-PNT network may be relatively low as compared to a total capacity of the Cell-PNT network. In such scenarios, the remaining data exchange capacity in the Cell-PNT network may be advantageously used for non-PNT related data exchange, such as voice data, video data, and/or general data exchange.

In some embodiments, at a first time, a server of a cellular network (e.g., the Cell-PNT network) receives a request for positioning signal assistance data from a mobile device. The server transmits positioning signal assistance data to the mobile device using a control or data plane of the cellular network. An estimated position of the mobile device is determined using the positioning signal assistance data and positioning signals transmitted by the cellular network. At a second time, the server of the cellular network receives first data from the mobile device. The server transmits second data to the mobile device using the data plane of the cellular network. This demonstrates that the Cell-PNT network may perform PNT services and support exchanging data via the 5G NR technology.

While such a system can be frequency agnostic and can operate in any frequency band, there are significant indoor penetration advantages that make systems close to 1 GHz efficient and cost effective for cellular and PNT purposes. In one embodiment, the Cell-PNT system works in the US band from 902-928 MHz band. Some portions of this band such as M-LMS band or M-LMS band in combination with other bands could be used for deploying the Cell-PNT system described above.

In one configuration, for example, the DL could be between 918 and 928 MHz and the UL could be between 902 and 907 MHz. In one configuration, the scheduler of the Cell-PNT for the DL and UL data and control channels can be configured to efficiently manage interference to other devices in adjacent or nearby bands by scheduling transmission only in some portions of the full bandwidth and/or some portion of the time and/or at some geographic locations/areas, depending on priority users of the band. Interference impact in the band can be, potentially, determined using listening capabilities on the base station to identify other users in the band and help adaptively manage the impact on other systems.

Another aspect concerns access and availability of the PNT signals in the cellular network for use to a wider set of users (including users of another cellular network) beyond the specific cellular network subscribers. Aiding or assistance information may be provided to, optionally, access-controlled UEs that have any form of data connectivity (e.g. data connectivity of this specific cellular network, WiFi, another cellular network's data connectivity), through a data connection to an assistance server that provides information to facilitate access and usage of the dedicated PNT signals for position/timing application. This application discusses the approach and mechanism for open access to the cellular network positioning signals for PNT services.

Systems and methods disclosed herein are directed to the design, deployment, and operation of a cellular PNT (Cell-PNT) capable network that is operable to provide data services as well as enhanced position, navigation, and timing (PNT) services to UEs, such as mobile devices (e.g., phones, laptop computers, tablets, or other devices). In some embodiments, the Cell-PNT network may utilize 5G NR signals to transmit PRS for position estimation of the UE. In some embodiments, the Cell-PNT network may be a Third Generation Partnership Project (3GPP) NR-based wide area cellular network covering both indoor and outdoor environments. The network could operate in FDD mode, TDD mode, or in a downlink-only mode in a carrier aggregation with another FDD or TDD cellular network.

The Cell-PNT network advantageously provides three dimensional location services and precise timing services within a certain target accuracy relative to UTC, and in some applications, requiring traceability and verifiability relative to UTC. In some embodiments, the Cell-PNT network may be based on a 5G NR design, aligned with 3GPP global standards, thereby enabling and ensuring broad access to global ecosystem partners for chipsets, equipment, and software. The use of 5G NR technology and the incorporation of 5G PRSs provide a foundation for the Cell-PNT network.

However, there are many considerations beyond merely transmitting PRSs as the positioning reference when building an accurate, resilient, and cost-effective Cell-PNT network. A Terrestrial Beacon System (TBS), as disclosed in ATIS contribution ESIF-ESM-2015-0038R001, MBS-ICD, includes a network of dedicated, highly synchronized transmitter beacons that transmit spread spectrum signals. These signals may use a combination of CDMA (e.g., using different Pseudo-Random Noise (PRN) codes when transmissions overlap), TDMA, and frequency-offset multiple access.

The cellular (e.g., 5G NR) PRS transmissions are based on the similar concepts of CDMA, including different PRN sequences for PRS transmission from different network entities to reduce the correlation of the orthogonal frequency-division multiplexing (OFDM) PRS symbol transmissions that occur in the same frequency and time, TDMA (through PRS muting), and frequency-offset multiple access (through the comb patterns used for PRS transmission). In some embodiments, the techniques and algorithms used by the TBS may be incorporated into the Cell-PNT network disclosed herein.

U.S. Pat. No. 9,176,217, issued Nov. 3, 2015, and U.S. Pat. No. 9,291,712, issued Mar. 22, 2016, are both assigned in common with the present application, and both are incorporated by reference as if fully set forth herein. These patents disclose that PRN code selection (CDMA), frequency offset (frequency offset multiple access), and slot (TDMA) are three dimensions used in the cell organization of a terrestrial-based PNT system.

By comparison, in the Cell-PNT network disclosed herein that uses PRSs, the dimensions considered for cell organization are PRS ID (PRN code), PRS pattern (comb pattern/frequency offset), and PRS muting (TDMA). These metrics may be used to design a Cell-PNT network that maximizes the number of ranges available as well as the SINR (signal-to-interference noise ratio) for the ranges available to the receiver in various parts of the network.

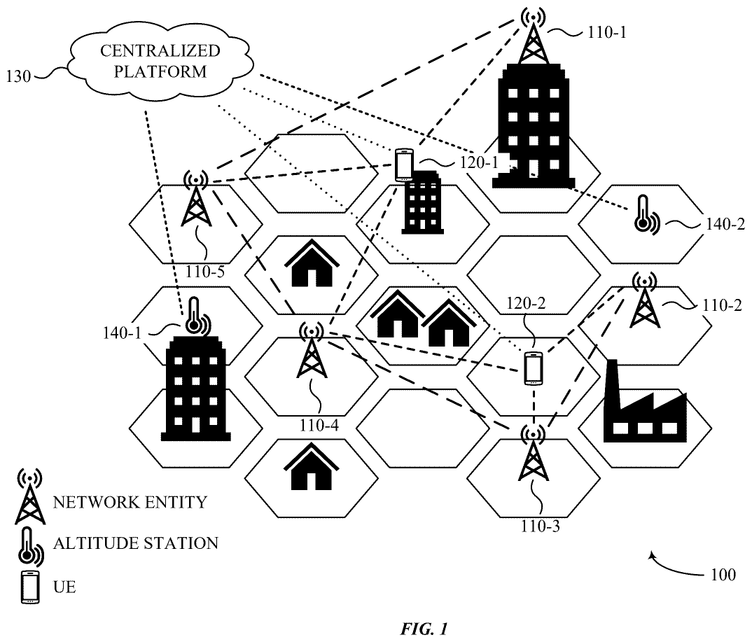

FIG. 1 is an example of a network 100, in accordance with one or more implementations described herein. The network 100 may include a quantity of devices configured to support operations and signaling of the network 100. For example, the network 100 may support a quantity of network entities 110 (e.g., network entity 110-1, network entity 110-2, network entity 110-3, network entity 110-4, network entity 110-5), a quantity of UEs 120 (e.g., UE 120-1, UE 120-2), a centralized platform 130, and a quantity of altitude sensors 140 (e.g., altitude sensor 140-1, altitude sensor 140-2). The network 100 may be an example of a cell-PNT network, such that the network 100 may support providing positioning services to UEs 120 associated with the network 100.

It should be understood that although the objects (e.g., devices, such as network entities 110, UEs 120, altitude sensors 140, buildings, houses) illustrated in FIG. 1 are depicted in given sizes, the objects may be implemented with other various sizes. Likewise, it should be understood that although the objects illustrated in FIG. 1 are depicted in given quantities, the objects may be implemented with other various quantities. It should be understood that the components illustrated in FIG. 1 are exemplary, and networks that include additional components not illustrated and/or include less components fall within the scope of the example illustrated with respect to FIG. 1.

The network entities 110 may be examples of base stations, network nodes, TRPs, or other devices configured to perform operations or communicate signaling associated with the network 100. For example, the network entities 110 may be configured to communicate with the UEs 120 of the network 100. In some examples, the network entities 110 may support communicating with UEs not associated with the network 100, such as UEs registered to a different network (e.g., than the network 100). In some cases, the network entities 110 may be configured to support 5G NR, such that the network entities 110 may perform operations and communicate signaling associated with supporting 5G NR standards. Additionally, or alternatively, the network entities 110 may be configured to perform operations and communicate signaling associated with supporting a cell-PNT network. That is, the network entities 110 may perform operations and communicate signaling to provide positioning services to UEs 120 registered to the network 100. For example, the network entities 110 may be configured to transmit PRSs to the UEs 120 registered to the network 100. In some examples, the network entities 110 may additionally support providing positioning services to UEs 120 associated with a different network than the network 100. That is, the network entities 110 may be configured to transmit PRSs to the UEs 120 registered to the different network.

The UEs 120 may be examples of wireless devices such as mobile phones, tablets, laptop computers, smart devices (e.g., internet of things (IoT) devices), or other devices configured to perform operations or communicate signaling associated with the network 100. For example, the UEs 120 may be configured to support 5G NR, such that the UEs 120 may perform operations and communicate signaling associated with supporting 5G NR standards.

Additionally, or alternatively, the UEs 120 may be configured to receive positioning services from the network 100 (e.g., via the network entities 110). Although the UEs 120 are depicted as being included within the network 100, the UEs 120 may be associated with (e.g., registered to) the network 100 or another network. That is, the UEs 120 may be configured to receive positioning services from the network 100 if the UEs 120 are registered to the network 100 or, in some cases, if the UEs 120 are not registered to the network.

The centralized platform 130 may be a server or a computing device configured to communicate with the network 100 (e.g., devices of the network 100, including the network entities 110, the UEs 120, and the altitude sensors 140). For example, the centralized platform 130 may be configured to communicate signaling with the network entities 110 to facilitate providing positioning services to the UEs 120. In some cases, the centralized platform 130 may support configuring the UEs 120 to receive the positioning services from the network 100. That is, the centralized platform 130 may enable UEs 120 to receive signaling from the network 100 (e.g., the network entities 110), despite the UE 120 not being registered to the network 100.

The centralized platform 130 may communicate with the altitude sensors 140 to determine additional positioning information associated with the UEs 120. For example, the centralized platform 130 may receive altitude measurements from the altitude sensors 140, which may be used for comparing with measurements from the UEs 120 to determine positioning information of the UEs 120.

The centralized platform 130 may be configured to support communications beyond the network 100, such as with other networks 100. That is, the centralized platform 130 may facilitate communications for one or more networks including the network 100 to provide positioning services to the UEs 120. In some cases, the centralized platform 130 may communicate with the network 100 to provide network synchronization solutions. In some cases, the network 100 may implement strategies for network synchronization and timing solutions.

Network synchronization may be instrumental for accurately and reliably estimating locations of UEs 120 using Multilateration, as well as for timing. For example, each nanosecond of error in timing may result in an approximately 0.3m error in position measurements because RF transmission travels at the speed of light (3×10⁸ m/s) and covers approximately 0.3m in 1 nanosecond. This may result in a range error of approximately 0.3m and a combination of measurements with Geometric Dilution of Precision or GDOP of 1, leading to approximately 0.3m of position error. Various methods can be used to synchronize the network to the level required for PNT services.

The network 100 may implement a leader-follower topology as the network architecture, in which one network entity 110 (e.g., node), referred to as the leader (e.g., network entity 110-1), controls some aspect of other network entities 110 (e.g., nodes), referred to as followers (e.g., network entity 110-2, network entity 110-3, network entity 110-4, network entity 110-5). In some embodiments, the network 100 may maintain relative and absolute time synchronization wirelessly using a leader-follower topology of network entities 110 with a UTC-based clock at a leader network entity 110-1. For example, the leader network entity 110-1 may implement a NIST-disciplined Cesium atomic clock that uses the Time and Measurement Service from the NIST or equivalent, other absolute time sources such as time-distribution-over-fiber disciplined clock, or the like, and/or, holdover clocks tied to an absolute source (e.g. Cesium & GPS, Rb & GPS or the like).

Techniques described in co-assigned U.S. Provisional Patent Application, 63/495,367, filed Apr. 11, 2023, all of which is incorporated by reference herein, may be used to design a cost-effective method to distribute traceable time through a leader-follower network. The leader-follower topology (as described in co-assigned U.S. Pat. No. 10,231,201, issued Mar. 12, 2019, and in co-assigned U.S. patent application Ser. No. 18/495,490, which was filed on Oct. 26, 2023, both of which are incorporated by reference herein in their entirety) may be an example of a mesh network that maintains timing synchronization to UTC wirelessly through the listening capability at each network entity 110 of neighboring network entity PRS transmissions that are within range. The coordinates of antennas of the network entities 110 may be determined up to sub-meter accuracy (e.g., more accurate than 50 cm) to enable the use of these coordinates in timing and position trilateration without impacting accuracy. In some cases, some 4G/5G NR cellular systems may only require network entity synchronization on an order of a microsecond.

The International Telecommunication Union Telecommunication Standardization Sector (ITU-T) specifies the requirements and architecture for synchronization in packet networks, particularly for frequency synchronization. According to the standard ITU-T G.8271/Y.1366 in Table 1, “Time and Phase Synchronization Aspects of Telecommunication Networks”, a 1.5 us time synchronization requirement for Time Division Duplexing (TDD) is shown.

In some embodiments (as described in the '490 Patent Application and in the '298 Patent Application incorporated above), one or more signal monitoring units (SMUs) may be deployed within a region associated with the network 100 to provide timing corrections associated with in-network and/or out-of-network network entities 110. The SMUs may be co-located at or be part of network entities 110 of the region, and/or located at other positions within the region. Given known coordinates of network entities 110 and SMUs within the region, the SMUs are operable to listen to signals from the network 100 as well as to signals from other networks and to provide a timing correction assistance service for network entities 110 and/or UEs 120 associated with those networks. Such timing assistance data may be provided as timing correction data to other network operators, and/or directly to the UEs 120 via cellular communication signals, or as an over-the-top data transmission. In embodiments where an SMU is co-located with a network entity 110, one or more receive chains of the network entity 110 may be tuned to a frequency of other networks to generate the timing assistance data.

The present embodiments provide scalable and cost-effective time synchronization techniques capable of achieving significantly tighter time synchronization as compared to conventional solutions, potentially by orders of magnitude, implemented into a 5G NR network, thereby enabling a robust and accurate positioning (e.g., PNT) service. In addition, the systems and methods disclosed herein may advantageously transfer time wirelessly in a mesh network of network entities 110 and facilitate precise transmission synchronization of the PRSs by accurately estimating a delay of the positioning signals (PRSs) as they pass through transmitter hardware, cables, and all components up to the phase center of the antenna.

Time synchronization techniques which may be applied to the Cell-PNT network disclosed herein are described in the '201 Patent incorporated above, U.S. Pat. No. 9,967,845, issued May 8, 2018, May 8, 2018, and U.S. patent application Ser. No. 18/631,154, filed Apr. 10, 2024, all of which are assigned in common with the present application incorporated by reference as if fully set forth herein.

In the network 100, the two-way time transfer (TWTT) concept of transferring time by listening to other transmissions when not transmitting may be implemented (as described in co-assigned U.S. Pat. No. 9,057,606, which was issued Jun. 16, 2015, and which is incorporated by reference herein in its entirety, and in the '845 Patent incorporated above). In the network 100, each network entity 110 may listen to other hearable PRS transmissions when its own PRS transmission is muted, and derive time-of-arrival measurements from the PRS transmissions of other network entities 110. Using such timestamped PRS measurements from two network entities 110 that may hear each other, a two-way time transfer measurement between two network entities 110 may be derived. Such a listening capability, for example, may be implemented using a standard network entity 110 architecture by using the digital-pre-distortion PA feedback path that is commonly used in network entities 110 for PA linearization (as described in the '201 Patent incorporated above) or through another available receive chains. In general, TWTT measurements may be derived by listening to PRS transmissions during times of muting (in FDD mode), or, more generally, not transmitting (e.g. in TDD mode), through a receiver chain tuned to transmission frequency.

Once the individual TWTT measurements for various network entity 110 pairs are obtained, they are sent to a TWTT server (as described in the '490 Patent Application incorporated above) to compute the TWTT network synchronization corrections for a network entity 110. The timing correction may either be fed back to the network entities 110 and applied to adjust the transmit timing, or, maintained as timing corrections in a cloud database (e.g., at the centralized platform 130) to be provided as part of PRS assistance data. For example the PRS assistance data may include a timing correction for each network entity 110 that the UEs 120 may apply to the TOA estimates derived by using the signals from the network entities 110, before using them for position or time estimation.

In the network 100, the network entities 110 may be considered to form the leader-follower topology which may implement the listening capability during PRS muting, thereby allowing PRS transmissions of other network entities 110 to be heard and used to measure the TOA. Once the TOAs of pairs of network entities 110 are available, TWTT measurements may be formed and optimal algorithms may be applied (as described in the '490 Patent Application incorporated above) to obtain timing corrections for each network entity 110.

Establishing timing synchronization involves time synchronization in the transmit chain hardware (as described in the '606 Patent incorporated above) to align the transmit samples to pulse per second (PPS), which may involve fine time estimation using high-speed clocks of the PPS to sample clock error. Similarly, this may include applying a correction to the transmit time or using a time correction for signal measurements from that transmitter.

PRS configurations, including PRS sequences, comb patterns, and muting strategies for various network entities 110 of the network 100, are designed, selected, and utilized to achieve a terrestrial based positioning-enabled network (e.g., a terrestrial PNT network). Such a network may manage PRS interference to enable the reception of sufficiently quality PRSs to achieve targeted positioning quality within the designated coverage area.

In some embodiments (as described in co-assigned U.S. Pat. No. 10,608,695, which was issued Mar. 31, 2020, and which is incorporated by reference herein in its entirety), beacon transmit parameters may be selected. These include PRN sequence, slot, and frequency offset for minimum interference. The selected parameters may enable enhanced positioning performance for UEs 120 in the coverage area. In the network 100, the corresponding dimensions are PRS ID (PRN code), PRS resource element pattern (comb pattern/frequency offset), and PRS muting (TDMA). These network design parameters may be applied to the selection of PRS configurations to enable low interference between PRS transmissions which facilitates better positioning performance. In some embodiments, it may be unnecessary for each network entities 110 to transmit the PRSs to achieve a target positioning performance. For example, a subset of network entities 110 may transmit the PRSs to achieve a target positioning performance. Such a subset may be determined by optimizing the subset selection using metrics (such as GDOP) that affect positioning performance, such as to select parameters to form an optimal PRS network configuration for high-performance PNT.

In some embodiments, UE processing algorithms for accurate ranging measurements and trilateration/timing may be implemented to enhance the accuracy and reliability of the positioning performance. The following documents disclose results based on such techniques: a US-DOT report titled “Complementary PNT and GPS Backup Technologies Demonstration Report;” an EU-JRC Report on “Assessing Alternative Positioning, Navigation and Timing Technologies for Potential Deployment in the EU;”. In addition, the following documents disclose results based on such techniques: a paper presentation at ION ITM 2022 showing positioning and navigation results titled “TerraPoiNT: Terrestrial Navigation System;” and a paper presentation at ION PTTI 2022 showing time transfer techniques titled “A Novel Method to Transfer Time Using the Terrestrial Timing System”. In other embodiments, technology for ranging and trilateration using OFDM reference signals in 4G cellular networks may be used as disclosed in a paper presentation at ION GNSS+2023 titled “Resilient 3D Navigation and Timing System using Terrestrial Beacons and Cellular Signals.” In the context of the network 100, once a channel estimate in the frequency domain is obtained using the PRS, similar techniques to those described in co-assigned U.S. Pat. No. 8,130,141, which issued Mar. 6, 2012, all of which is incorporated herein by reference in its entirety, may be applied to estimate the TOAs using a MUSIC algorithm.

Alternately, techniques using code and Doppler-based TOA estimation (for example, as described in co-assigned U.S. Pat. No. 10,042,037, which issued Aug. 7, 2018, co-assigned U.S. Pat. No. 10,880,678, which issued Dec. 29, 2020, and co-assigned U.S. Provisional Patent Application No. 63/595,1054, which was filed on Nov. 3, 2023, all of which are incorporated by reference herein in their entirety that were developed for cellular reference signals), may be applied to the PRSs to estimate TOAs with good performance and low complexity. In addition, interference cancellation (e.g., as described in co-assigned U.S. Provisional Patent Application No. 63/589,298, which was filed Oct. 10, 2023, all of which is incorporated herein in its entirety), adapted to PRSs to cancel PRSs that overlap in frequency and time with the target PRS may improve SINR (signal to interference plus noise ratio) and enable detection of more PRSs or provide improved TOA performance.

Once TOA measurements are determined, a pseudorange may be formed for each measurement, and, various methods of multilateration or position estimation may be used to estimate the position of a UE 120. For example, a non-linear global L1-norm minimization-based multilateration (as described in co-assigned U.S. Pat. No. 9,720,071, which was issued on Aug. 1, 2017, and co-assigned U.S. Patent Application No. U.S. Ser. No. 17/769,815, filed Apr. 18, 2022, all of which are incorporated herein by reference in their entirety) or piecewise linear loss function weighting of TOA as part of multilateration (as described in the '815 Patent Application incorporated above, and in co-assigned U.S. Provisional Patent Application No. 63/568,554, which was filed on Mar. 22, 2024, and which is incorporated herein by reference in its entirety) may be used to determine an accurate position estimate. In some cases, time estimation may be considered as a subset of position estimation, where time may be obtained as a by-product. Alternately, time may be estimated with known coordinates of the UE 120.

The network 100 may provide a three-dimensional positioning service which, in some embodiments, includes a barometric-sensor-based differential Z-axis solution. Conventionally, terrestrial positioning systems, GPS, and GNSS, may be limited with respect to estimating the height of a UE 120 through trilateration. For example, GPS/GNSS systems may be associated with a limited vertical accuracy relative to horizontal accuracy due to poor Vertical Dilution of Precision (VDOP), since satellites are above the Earth's surface. Terrestrial systems may have a similar limitation with respect to estimating the height of a UE 120 through trilateration, since terrestrial transmitters are positioned essentially on the same plane. While height differences in terrestrial transmitter deployment may help to improve the VDOP, the altitude accuracy may be limited for traditional terrestrial PNT systems. Indoor locations, where accurate UE height information is most relevant and critical, may prove to be challenging environments for some GPS and/or terrestrial systems.

In some embodiments, a sensor-based Z-axis solution that delivers precise “floor-level” vertical positioning is disclosed. This Z-axis solution may be integrated into the network 100 to offer comprehensive and full three-dimensional position solutions.

An accurate Z-axis solution may be obtained, for example, using a calibrated reference network of cost-optimized altitude stations 140 measuring pressure (as described in co-assigned U.S. Pat. No. 10,551,271, which issued on Feb. 4, 2020, and U.S. patent application Ser. No. 18/053,254, filed on Nov. 7, 2022, all of which are incorporated herein by reference), collecting and managing this reference pressure information in the centralized platform 130 (e.g., the cloud), enabling computation of accurate altitude by performing the calibration of the pressure sensor on the device (either on the altitude station 140 or on the centralized platform 130, as described in co-assigned U.S. Pat. No. 10,514,258, which issued on Dec. 24, 2019, U.S. Pat. No. 11,555,699, which issued on Jan. 17, 2023, and U.S. Pat. No. 11,333,567, which issued on May 17, 2022, all of which are incorporated herein by reference in their entirety), determining a reference pressure based on the two-dimensional position (coarse quality if sufficient) of the UE 120, using the reference pressure assistance for that two-dimensional position in combination with the calibrated pressure reading on the altitude station 140 or the UE 120 to determine altitude and/or floor (either at the UE 120 or on the centralized platform 130) of the altitude station 140 or the UE 120 (as described in the '141 Patent and the '606 patent incorporated above, and in co-assigned U.S. Pat. No. 11,215,453, which issued on Jan. 4, 2022, and U.S. patent application Ser. No. 18/322,874, which was filed on May 24, 2023, all of which are incorporated herein by reference in their entirety).

By leveraging two-dimensional positioning data and 5G NR data connectivity of the network 100, the Z-axis solution may be integrated into the network 100, thereby providing a seamless service experience for end-users (as described in the '271 patent, the '254 patent application, the '874 patent application, the '453 patent, and the '258 patent incorporated above, as well as U.S. Pat. No. 11,536,564, which issued on Dec. 27, 2022, all of which is incorporated herein by reference in its entirety).

In some embodiments, the network 100 may allow its positioning service to be accessed by compatible UEs 120. In some embodiments, the UEs 120 may be registered or part of the network 100. In some embodiments, the UEs 120 may not be registered nor part of the network 100. In some embodiments, there may be a combination of some UEs 120 that are registered or part of the network 100, and other UEs 120 that are not registered nor part of the network 100.

In some embodiments, the network 100 may use a downlink (DL) PRS. In some embodiments, the network 100 may implement a duplex TDD/FDD system with PRS in the downlink and Sounding Reference Signals (SRSs) in the uplink (UL). From a positioning perspective, the availability of SRSs enable operation of the cellular (e.g., 5G NR) network 100 without the fine timing synchronization and provide accurate position and navigation using Round-Trip-Timing (RTT) measurements. For example, a PRS TOA may be measured on the downlink at the UE 120, and the SRS TOA may be measured on the uplink at the network entity 110. These measurements may be combined, along with other delay corrections, to form an RTT measurement. The RTT measurement in time, after multiplication by the speed of light, may provide a range measurement between the UE 120 and the network entity 110. Using a minimum of at least two RTT range measurements through PRS and SRS measurement pairs corresponding to multiple UE-network entity pairs, a two-dimensional or three-dimensional position solution may be computed. Alternately, UL-TOA measurements may be obtained using SRS signals at the network entity 110 to determine the two-dimensional position directly, assuming that the network entity 110 is already synchronized.

In another embodiment, one RTT measurement may be combined with PRS TOA measurements and/or with SRS TOA measurements from other network entities 110 to compute a UE position estimate. In all cases, a three-dimensional position (with a more accurate Z-axis) may be computed by the network 100 with a pressure-based solution using, for example, reference pressure derived from a network of reference altitude sensors 140 and a calibration-managed UE pressure sensor measurement.

In one embodiment, a coarse two-dimensional position may first be estimated using TOAs estimated using the PRS and/or SRS signals of the network 100, and then a Z-axis estimate may be found using that coarse two-dimensional estimate (latitude and longitude). The Z-axis estimate may be used along with determining the reference pressure at that location using reference pressure assistance; then, combined with a calibrated device pressure to determine the Z-axis estimate. The Z-axis estimate in combination with the TOAs from PRSs and/or SRSs may be used to determine a finer estimate of the two-dimensional coordinates (latitude and longitude) as part of the final fine three-dimensional estimate.

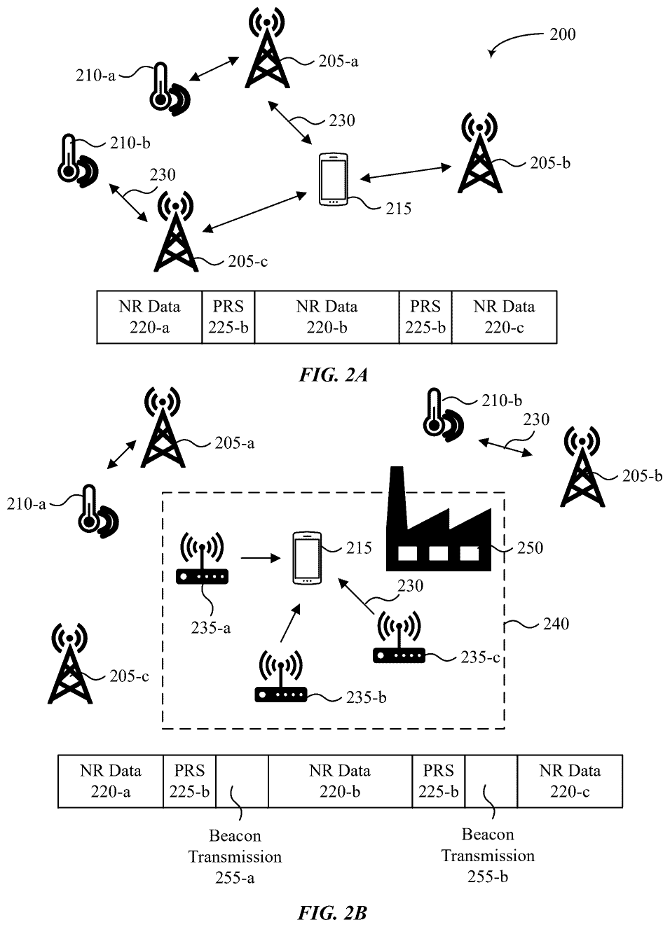

The network 100 shown in FIG. 1 may be a macro-level layer that provides a basic positioning service with key performance indicators (KPIs) targeted for wide areas. Whereas, FIG. 2 may be a schematic of an augmented network 200, in accordance with some embodiments. The augmented network 200 may also support PRS-based beacon-only deployments for providing additional site-specific, value-added PNT accuracy and resiliency. Therefore, the augmented network 200 may integrate coexistence between the macro-layer and underlying beacon-only deployments when available.

There are some positioning and navigation applications such as eVTOL, drones, and self-driving cars where the accuracy/reliability/resiliency of the network 100 and PNT solution required may be quite different from what may be achieved in a standard cellular network. To support such applications within a same frequency band used for the larger network 100 mentioned above, one approach may include setting aside time intervals in the larger network 100 for a dedicated augmentation network 200 meant for positioning signal transmissions and optionally, broadcast data related to PNT. Such an augmentation network 200 may be deployed in target areas (e.g., vertiports or streets) and use these time intervals for transmitting positioning signals (and optional broadcast data). This system design approach, by virtue of the dedicated beacons, de-couples the requirements of such a dedicated network with specific requirements and the larger network 100 and, thus, makes the overall cost more efficient, for example, by relaxing the requirements (e.g. with respect to reliability and resiliency) on the larger network 100.

Macro network entity hardware for cellular (e.g., 5G NR) services with power output greater than a few watts commonly use digital pre-distortion (DPD) RF receive chains that may tap into the transmitter signal at a box output, and feedback that signal for PA linearization algorithms. The PA linearization algorithms may operate on a processor or other hardware platform using I/Q samples from the RF chain. The '201 Patent incorporated above discloses two-way time transfer with a leader/follower topology. This includes listening through DPD linearization to the receive path of the transmitter. This may be applied to listening to PRSs during times of muting (in FDD mode). More generally, while not transmitting (in TDD mode), this may be applied through a receiver chain tuned to transmission frequency (it could re-use a DPD receive RF chain or use a separate RF chain), deriving TOA measurements of other hearable transmitters, and transmitting the TOA measurements to a TWTT server to compute the TWTT network synchronization corrections. The timing correction may either be fed back and applied to adjust and correct the transmit timing, or be maintained as timing correction in a cloud database (e.g., the centralized platform 130) to be provided as part of PRS assistance data to the UE 120 when using the PRS TOAs for positioning estimation purposes.

In some embodiments, the DPD RF receive chains may be used for multiple purposes including for Two-Way Time Transfer (TWTT) and spoofing detection (when not transmitting). During transmission, there may be a small amount of reflection transmit signal from the antenna that may be tapped using a circulator into the receive path along with any directly coupled transmitted signal. By using the TOA estimation of the reflected signal relative to the transmitted signal, the cable and antenna delays may be estimated. U.S. Pat. No. 9,057,606, issued Jun. 16, 2015, is assigned in common with the present application, and is incorporated by reference as if fully set forth herein, discloses timing synchronization in transmitter hardware, and the maintaining and application to either correct the timing of the transmitter or provide the correction through assistance computed at a server (e.g., the centralized platform 130). In some embodiments, TWTT may not rely on the DPD receive path. For example, when the DPD receive path is not available, another available RF receive chain may be set up to tune to the transmit frequency to receive the transmitted signal for use in TWTT/spoofing detection.

In some cases, one or more network entity PRSs may be spoofed by a bad actor in order to produce incorrect positioning estimates for UEs 120 in the area. These spoofed PRSs may have some inconsistencies in their transmissions. These inconsistencies may be detected in the form of PRS parameters (e.g., PRS ID) or based on the inconsistent TOAs from expected PRS IDs at a given location. In some embodiments, the TWTT capability at a network entity 110 with known coordinates, and a list of known coordinates of the network entity 110 from an authentic source (e.g. the centralized platform 130) that are hearable at each given network entity 110, allows for spoofing detection of network entity PRSs. In addition to TWTT capability, a listening capability of the network entity 110 may enable integrity alarms by checking the transmissions from the network entities 110 for various anomalies including timing and content of transmissions. In some cases, idle periods on the DL and/or when there are slots with no DL transmission scheduled by the scheduler (beyond PRS muting durations) may be used to listen to the signals in the environment. For example, synchronization signals such as PSS/SSS/BCH, as well as control channels, may be listened to; and messages such as SIB/MIB may be decoded, for expected neighboring cells, to identify expected inconsistencies in data content by comparing against known data about the network entities 110 available within the network 100.

The network 100 may be configured for greater resiliency (e.g., jam resiliency) at the UEs 120 by using techniques for narrowband jammer detection and removal (as described in co-assigned U.S. Pat. No. 10,281,556, which issued May 7, 2019, and co-assigned U.S. Pat. No. 9,874,624, which issued Jan. 23, 2018, all of which are incorporated by reference herein in their entirety). Such techniques may be implemented in an OFDM system since the FFT of the input signal is already done as part of UE processing. One other technique to mitigate jammers is through a fast AGC that may respond to the dynamics of the jammer.

The network 100 may use cellular (e.g., 5G NR) applications for different applications while considering factors such as integrity, continuity, and availability. One potential approach for enhancing availability and continuity metrics is the improvement of reliability in individual network entities 110 or reliance on network-level redundancy. For example, network level redundancy may be improved by using more than the minimum PRS measurements for positioning during the PRS parameter network design. Most network entities 110 generally have multiple Tx and Rx chains (e.g., transmit and receive chains), and any failures in one or more Tx/Rx chains may be mitigated by using other available chains (e.g., with some loss in quality of service (QOS) due to diversity loss). Multiple sources of timing at the leader network entity 110-1 may also be used to increase resiliency to timing failures from individual sources.

From an integrity perspective, the UE 120 may validate the PRSs and measurements it is using in a positioning solution or timing based on performing Receiver Autonomous Integrity Monitoring (RAIM) on the UE 120, as well as by checking with the network 100. For example, validation may be determined from an integrity server through an encrypted interface to authenticate all the PRS measurements being used in the solution. The integrity server may maintain a list of spoofed signals based on the network entity reports from a listening capability on the network entity 110 and may validate the measurements used by the UE 120, as well as flag the spoofed signals. In some cases, the UE 120 may also receive a list of only authentic PRSs to acquire and use in its positioning solution from an assistance server (e.g., the centralized platform 130). The assistance may itself be received through an encrypted channel available as part of the network 100 natively, or through a secure data plane interface.

In some embodiments, the network entity 110 may be part of a leader-follower topology having listening capability during PRS muting, thereby allowing PRSs of other network entities 110 to be heard and used to measure TOAs. Once the TOAs are available, algorithms may be applied to obtain timing corrections for each network entity 110.

In the cellular (e.g., 5G NR) framework, a resource block, such as a unit resource in the scheduler, occupies a resource space (e.g., slot) in the time and frequency domains (e.g. 180 kHz for 1 ms). As such, the network 100 provides a mechanism, due to the physical resource block (PRB) or PRB level transmit control capability available through the scheduler, to manage interference from the network 100 to other users in the frequency band, if and when required, by controlling the frequency occupancy or time occupancy of the transmissions. This mechanism may provide support that allows other systems to coexist better with the network 100.

In some embodiments, the network 100 may use the PRSs as a source for PNT data. PRSs are defined in the 5G NR specifications and provide a class of physical signals developed for the purpose of positioning and timing measurements. PRSs may include a group of specially designed reference signals, which are broadcasted by 5G (e.g., cellular) network entities 110. These signals are designed to be easily detectable in the presence of other signals, allowing 5G configured UEs 120 to measure and extract location and timing information accurately. By analyzing the timing (which is equivalent to measuring the distance), angle, and strength of the received PRSs, the UE 120 or centralized platform 130 in the network 100 may calculate and extract the UE's location via various algorithms such as multilateration.

FIGS. 2A and 2B are examples of a network 200, in accordance with one or more implementations described herein. FIG. 2A may describe a wide-area PNT network, and FIG. 2B may describe a wide-area PNT network augmented by a beacon-only network. FIGS. 2A and 2B describe communications between multiple devices, including base stations 205, UE 215, altitude sensors 210, and beacons 235. Base stations 205 may be examples of network entities 110, UE 215 may be an example of UE 120, and altitude sensors 210 may be examples of altitude sensors 140 as described with reference to FIG. 2 and FIG. 1, respectively.

FIG. 2A may be an example of a wide-area PNT network. Base station 205-a, base station 205-b, and base station 205-c may communicate with UE 215. For example, one or more of the base stations 205 may transmit and receive communications via connections 230, which may include NR data 220 and PRS 225. For example, base station 205 may transmit NR data 220 and UE 215 may transmit PRS 225. In some examples, base station 205 may communicate PRSs 225. In some examples, transmissions may alternate between NR data 220 (e.g., NR data 220-a, NR data 220-b, NR data 220-c) and PRSs 225 (e.g., PRS 225-b, PRS 225-a). Altitude sensors 210-a and 210-b may communicate data, such as air pressure data, to base stations 205, via connections 230.

FIG. 2B may be an example of a wide-area PNT network augmented by a beacon-only network. FIG. 2B may include beacon network 240, which may include one or more beacons 235 (e.g., beacon 235-a, beacon 235-b, beacon 235-c) communicating with UE 215. In some examples, beacon network 240 may augment the wide-area PNT network, which may improve communications. For example, the signal obstruction and disruption caused by obstacle 250 may be reduced or eliminated. Beacon transmissions 255 (e.g., beacon transmissions 255-a, beacon transmission 255-b) may be received intermittently between NR data 220 and PRS 225.

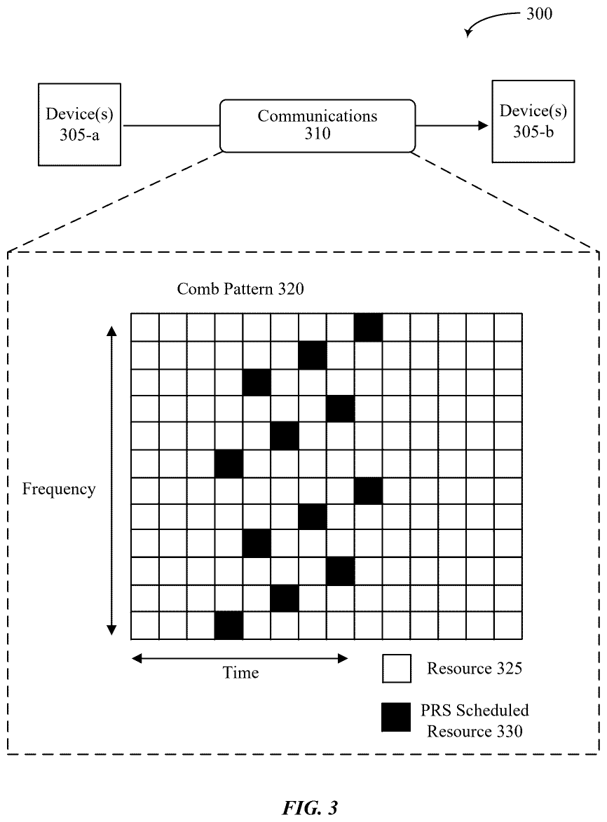

FIG. 3 is an example of a signaling diagram 300, which may be an example of communications 310 between one or more devices 305 according to comb pattern 320. For example, devices 305 may include base stations, network entities, UEs, beacons, and other devices as described herein. Comb pattern 320 may include a frequency and time domain, in accordance with one or more implementations described herein.

Comb pattern 320 illustrates an example of physical resource blocks (PRB), or resources 325, that may be scheduled in a dedicated PRS slot showing a comb-6 pattern transmission. For example, PRS scheduled resources 330 may be scheduled according to a comb-6 pattern. The comb pattern (e.g., comb-6) repeats every 6 sub-carriers in the frequency domain. Note that this pattern is repeated across the bandwidth, or time domain, of the PRS. Other slots not dedicated to PRS, that is, resources that are not PRS schedules resources 330, may contain data and are not shown in this figure. In the example shown in FIG. 3, one slot=1 ms subframe for 15 kHz carrier spacing. By communicating according to comb pattern 320, communication efficiency may be improved. Techniques described herein may be implemented in accordance with comb pattern 320.

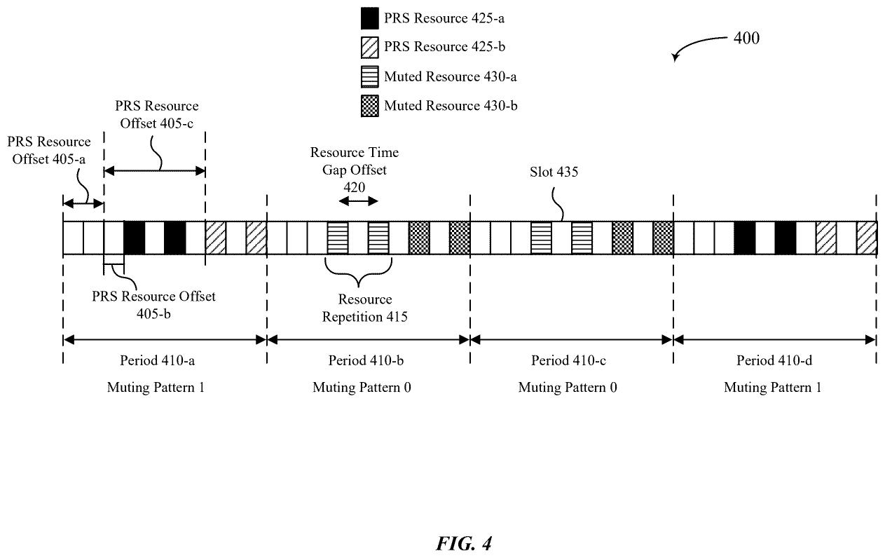

FIG. 4 is an example of a resource timeline 400 that may be an example of a muting pattern, in accordance with one or more implementations described herein. In some examples, FIG. 4 may be implemented by devices described herein, such as network entity 110, UE 115, or other devices. Resource timeline 400 illustrates a series of slots 435. Each slot 435 may have a PRS resource 425, a gap (e.g., resource time gap offset 420), where there is not a PRS resource 425, or a muted resource 430. During a muted resources 430, a PRS resource 425 is muted, and the device monitors for PRSs and refrain from transmitting PRSs. FIG. 4 illustrates a pattern of muted resources 430 and PRS resources 425.

Slot 435 may be repeated one or more times to form a PRS resource instance (that may contain gaps). The PRS resource 425 can be repeated multiple times to form part of a PRS resource set, or resource repetition 415. Some of the repeated instances can be muted to allow for other TRPs (transmit reception points) to transmit without interference between TRPs. For example, resource repetition 415 may include two PRS transmission resources that are muted resources 430 and a resource time gap offset 420 that includes slots 435 between the muted resources 430. TRPs may be an example of device that may implement the techniques described with reference to FIG. 4, as well as other figures describe herein.

Resources may be divided into periods 410 (e.g., period 410-a, period 410-b, period 410-c, period 410d) of a specified number of slots 435. Each slot 435 may represent a portion of time during which resources may be scheduled. For example, PRS resources 425 may be scheduled for transmitting PRSs. In some examples, a muted resource 430 may be scheduled in place of PRS resource 425. That is, resources may not be scheduled, and the slot may be a muted resource 430 where a device refrains from transmitting, and instead monitors for transmissions (e.g., PRSs) from other devices.

PRS resources 425 and muted resource 430 may be scheduled in a pattern, which may be referred to as a muting pattern. Muting patterns may be defined by a bit value, such as muting pattern 0 or muting pattern 1. For example, muting pattern 1 may be associated with period 410-a and 410-d, and muting pattern 0 may be associated with period 410-b and period 410-c. As described with reference to FIG. 4, muting pattern 1 may include patterns of PRS resources 425, and muting pattern 0 may include patterns of muted resource 430. Muting patterns may include PRS resource offsets 405, resource repetitions 415, and resource time gap offset 420.

For example, muting patterns may include PRS resource offsets 405, which may define the time, or slots 435, prior to beginning a PRS resource 425 pattern. For example, as described with reference to FIG. 4, each period 410 may include 10 slots 435. In some examples, PRS resources 425 may not be scheduled during the first slot 435 of period 410. The difference between the first slot 435 and the first PRS resource 425 (e.g., either PRS resource 425-a or PRS resource 425-b) may be referred to as a PRS resource offset 405-a. For example, at period 410-a, PRS resource offset 405-a indicates a difference of 2 slots 435 from the beginning of period 410-a.

Further PRS resource offsets 405 may define when different resource patterns begin. For example, muting pattern 1 may include PRS resource offset 405-b and PRS resource offset 405-c. PRS resource offset 405-b may indicate a one slot 435 distance between the PRS resource offset 405-a and the start of a pattern of PRS resource 425-a. PRS resource offset 405-c may indicate a five slot 435 distance between the PRS resource offset 405-a and the start of a pattern of PRS resource 425-b.

Muting patterns may include resource time gap offsets 420 and resource repetitions 415. For example, resource repetitions 415 may define multiple instances of a PRS resource 425 or muted resource 430. For example, there may be two instances of a PRS resource 425. Resource time gap offset 420 may define the slots between resource repetitions 415. For example, there may be a single slot 435 between each PRS resource 425, or muted resource 430.

Muting patterns of PRS resources 425 and muted resource 430 may allow for scheduling of PRS transmissions and scheduling of monitoring for PRS transmissions. For example, a device may transmit PRS signals during period 410-a according to muting pattern 1, and may monitor for PRS signals during period 410-b according to muting pattern 0. By periodically transmitting PRS signals and monitoring for PRS signals, devices may determine timing information and timing corrections, resulting in increased accuracy.

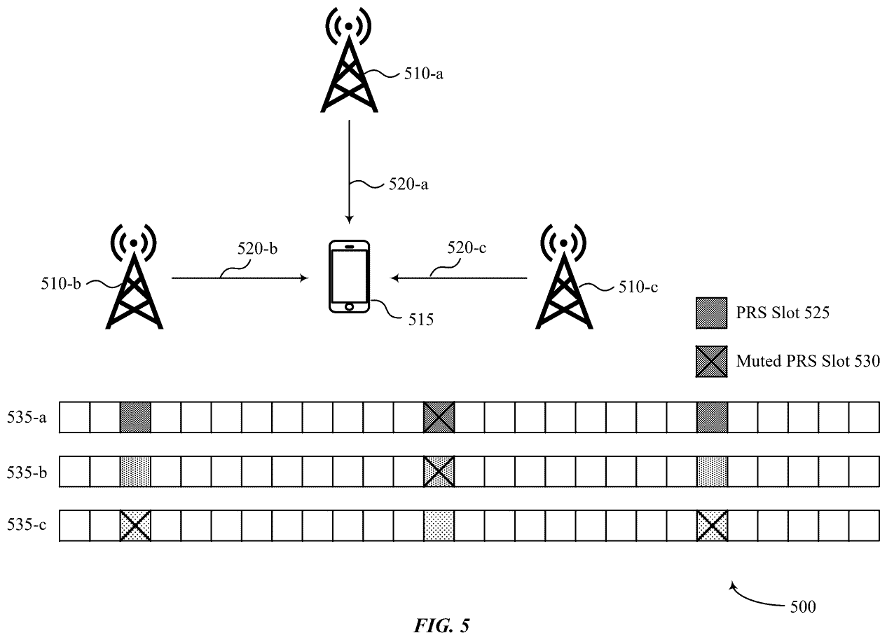

FIG. 5 is an example of a signaling diagram 500, which may be an example of one or more implementations as described herein. Signaling diagram 500 may describe communications between base stations 510 and UE 515. Base stations 510 (e.g., base station 510-a, base station 510-b, and base station 510-c) may be examples of network entities 110, and UE 515 may be an example of UE 120 as described herein with respect to FIGS. 5 and 1, respectively. Base station 510-a may communicate with UE 515 via connection 520-a, base station 510-b may communicate with UE 515 via connection 520-b, and base station 510-c may communicate with UE 515 via connection 520-c. Connection 520 may be a downlink channel. In some examples, base station 510 may transmit one or more PRSs during PRS slot 525 to UE 515 via connection 520.

PRSs may be communicated according to PRS configuration parameters, in accordance with some embodiments. The schematic, or signaling diagram 500, illustrates an example of various PRS configuration parameters such as resources, repetition, and muting. PRS on the downlink was first introduced in 3GPP release 9 in the LTE standard to provide dedicated reference signals for positioning use cases. Release 16 5G NR introduced PRSs with greater flexibility and parameter configuration to enable better accuracy and reduced interference (technical specification 3GPP TS 38.211). In order to improve PRS receptibility, these PRSs are transmitted during dedicated positioning subframes within the NR transmission, during which other signals are not transmitted, and therefore, limiting collisions with non-PRSs.

Position computation involves time of arrival (TOA) measurements of PRSs from multiple base stations 510 at the UE 515 and combining them using a computation method (e.g., multilateration) to estimate position. The position computation may be done at the UE 515 or at the location server in the core network (e.g., the Enhanced Serving Mobile Location Centre or Location Management Function; technical specification 3GPP TS 38.305) by knowing the coordinates of each base station 510 and the time synchronization among their transmissions. Similarly, timing at the UE 515 that is traceable to the timing of the base station 510 network may be determined from the PRSs using the TOA along with the coordinates of the associated base station 510.

The Cell-PNT network disclosed herein may use PRSs within the 3GPP NR framework. This allows the Cell-PNT network to use the 3GPP standardized 5G NR ecosystem of base stations and UEs, thus, leading to a cost-effective solution. UE receivers in the Cell-PNT network may use standard PRS algorithms or advanced algorithms for ranging and trilateration for further improved PNT performance. For example, standard 5G NR chipsets may be configured via software to support PRS measurement signal processing capabilities that may be used to estimate position. For the 5G NR base stations ecosystem, the 3GPP specifications allow flexible and dynamic allocations of PRSs within the network resources so that PRS deployments may be optimized for various positioning requirements. The base station 510 may configure and schedule PRS transmissions, which may include various parameters, including PRS periodicity, repetition, and bandwidth, etc.,

In some embodiments, signal penetration indoors may be obtained through PRS/SRS switched beams available in 5G NR for improved link budget. Beam switching may add additional duration when PRS is transmitted when used in combination with muting, which may be a drawback when used for the dual purpose of data and positioning. Some of the overhead may be overcome by coordinating the transmission of beams from surrounding base stations in such a manner that the beams from nearby base stations avoid pointing in the same direction. In some embodiments, PRS boosting is used, where the resource elements in the comb transmit pattern are transmitted with higher power while the overall power from the symbol remains the same, to improve the PRS link budget, while still keeping the power of the symbol within the PA limits. In some cases, the PRS boosting at the edges of the band may be controlled, if required, to meet an emission mask.

The '490 Patent Application incorporated above discloses a method for optimal two-way time transfer which may be implemented in the Cell-PNT network disclosed herein. The two-way time transfer technique is performed in the context of a mesh network having leader and follower nodes that have listen capability of the signals from other nodes, and may thereafter measure the time of arrival of those other nodes timestamped with the local clock when they are not transmitting. The timestamped TOAs are sent to a two-way time transfer (TWTT) server that determines the optimal timing correction per beacon and, optionally, sends back control to the beacon to adjust timing. In some examples, beacons may be base stations 510.

U.S. Pat. No. 10,608,695, issued Mar. 31, 2020, is assigned in common with the present application, and is incorporated by reference as if fully set forth herein, discloses a network design including GDOP metric, which may select a network design for good PNT performance and which may be implemented in the Cell-PNT network disclosed herein. A subset of base stations 510 transmitting PRSs constitute a network for PNT purposes. The GDOP of the PRS subset network would be designed to provide good-quality positioning within the coverage area. In some examples, base stations 510 may transmit PRSs according to various patterns 535 (e.g., pattern 535-a, pattern 535-b, pattern 535-c). Patterns 535 may include patterns of PRS slots 525 during which PRSs are transmitted and muted PRS slots 530, during which base station 510 refrains from transmitting PRSs. In some examples, base station 510 may receive PRSs during muted PRS slots 530.

In some examples, different patterns 535 may be associated with different base stations 510. For example, pattern 535-a may be associated with base station 510-a, pattern 535-b may be associated with base station 510-b, and pattern 535-c may be associated with base station 510-c. For example, base station 510-a and base station 510-b may transmit during PRS slot 525, during which base station 501-c refrains from transmitting during muted PRS slot 530, and vice versa. By varying the times each base station 510 is transmitting PRSs, collisions are reduced and signal reliability is improved.

### Open PNT Access to Cellular PNT-Capable Network

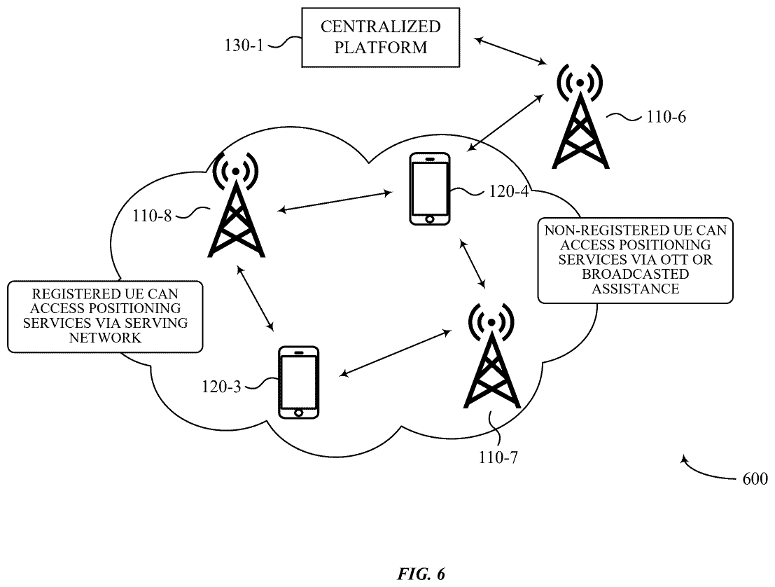

FIG. 6 illustrates an example of a network 600 that supports open PNT, in accordance with one or more implementations described herein. The network 600 may include a quantity of devices configured to support operations and signaling of the network 600. For example, the network 600 may support a quantity of network entities 110 (e.g., network entity 110-6, network entity 110-7, network entity 110-8), a quantity of UEs 120 (e.g., UE 120-3, UE 120-4), and a centralized platform 130-1, as described with reference to FIG. 1. The network 600 may be an example of a cell-PNT network, such that the network 600 may support providing positioning services to UEs 120 registered or not registered to the network 600.

In some cases, the network 600 is configured to provide positioning (e.g., terrestrial PNT) services to all compatible UEs 120 within a region, whether or not a given UE 120 within that region is registered to use the network 600. In such cases, the terrestrial PNT services using PRSs transmitted by the network 600 may be available to UEs 120 serviced by the network 600 (i.e. in-network UEs 120), as well as to UEs 120 serviced by other operators’ networks (i.e. out-of-network UEs 120). Specifically, for an out-of-network UE 120, based on a coarse UE location (e.g., determined using a “Cell ID” of a cellular network), over-the-top (“OTT”) PRS assistance data provided by the network 600 may be advantageously obtained from the centralized platform 130-1 associated with the network 600.

In the context of cellular network telecommunications, “Over-The-Top” (OTT) data may be transmitted via internet protocols independently of traditional telecom carriers' control. Unlike data exchanged in the control plane, which is managed and routed within the carriers' proprietary networks for signaling and network control, OTT services deliver content and services directly to users. This method allows OTT providers to provide data services without interfacing with the carrier's dedicated network operations or control mechanisms.

Having received the OTT PRS assistance data provided by the network 600, a UE 120 may then optionally request measurement gaps to enable PRS measurements using PRSs provided by the network 600. In some examples, the PRS measurements may also be done during the idle periods or pre-configured measurement gaps, such that an explicit measurement gap request may not be required from the UE 120. In wireless communication systems, a measurement gap may refer to a predefined period of time during which normal data transmission and reception activities are temporarily suspended to allow for specific types of measurements to take place. These measurements could include channel quality assessment, interference monitoring, or, as mentioned above, positioning reference signal (PRS) measurements.

During such measurement gaps, the UE 120 may advantageously tune to the network's band (e.g., a lower 900 MHz band, such as 902-928 MHz band) to measure the PRSs using the OTT PRS assistance data provided by the network 600. The UE 120 may then use the PRS measurements during/after the measurement gaps to determine timing/positioning on the UE 120 or compute a UE position by using an OTT or control plane interface to a position computation server or LMF of the network 600, and/or a position computation server of another network.

In some embodiments, measurement gaps may be requested, when required, by the UE 120 from the connected network (e.g., the network 600) using a cellular network-specific request, such as the Radio Resource Control (RRC) location measurement indication message to indicate the start and stop of the measurement gaps that are required to enable the PRS measurements. Through the location measurement indication, the UE 120 may inform the network 600 that it is going to either start or stop a location measurement (i.e., as described in Section 7.4.1.1 on Location Measurement Indication in 3GPP TS 38.305). The UE 120 may then use this measurement gap to make PRS measurements. In some cases, if measurement gaps are not available, then a voice or data connection may be stopped temporarily or terminated in order to tune to the network 600 to make the PRS measurements.

In some embodiments, registered users of the network 600 may access the PNT service in accordance with a data subscription. However, in some embodiments, PRSs and OTT PRS assistance data may be made available to non-registered users (e.g. 3rd party public and private operator subscribers). In some such embodiments, different levels of service may be provided to non-registered users based on a service level agreement made with such users or a network operator that the user subscribes to. For example, such levels of service may control position accuracy/precision, timing accuracy/precision, position availability, timing availability, a navigation error metric, power consumption, an update rate, and so on. The levels of service may further relate to packet error rate, packet retransmission rate, packet latency, sensor update rate, and/or one or more voice/video quality metrics.

In some embodiments, the UE 120 may advantageously download assistance data using a separate data channel, or over the air from a broadcast channel of the network 600 that is available to UEs 120 without a subscription. In some embodiments, a broadcast channel of a cellular network other than the network 600 may be used to transmit the PRS assistance data provided by the network 600 (e.g., using a 5G broadcast channel).

In some embodiments, coarsely synced or asynchronous cellular networks may be configured to allow a UE 120 (e.g., a UE 110-6) of another cellular network to tune to the network 600 to receive the PRSs generated by the network 600. The PRS assistance, in this case, also provides the time offset between the cellular network and the network 600 to enable the UE 120 to switch effectively to the network 600. In some cases, time offset assistance may be required along with the System Information (SI) of the other cellular network that establishes the relationship between SFN and UTC time of that network, in order to enable a timing receiver capability to generate a PPS signal aligned to UTC and a corresponding UTC timestamp. The SI mapping may also be provided as assistance to the UE 120.

In some embodiments, a synchronization signal block (SSB), a primary synchronization signal (PSS), a secondary synchronization signal (SSS), and/or a physical broadcast channel (PBCH)) may be involved for synchronization to receive the PRS on the network 600, and may be used for coarse time synchronization by non-registered users of the network 600.

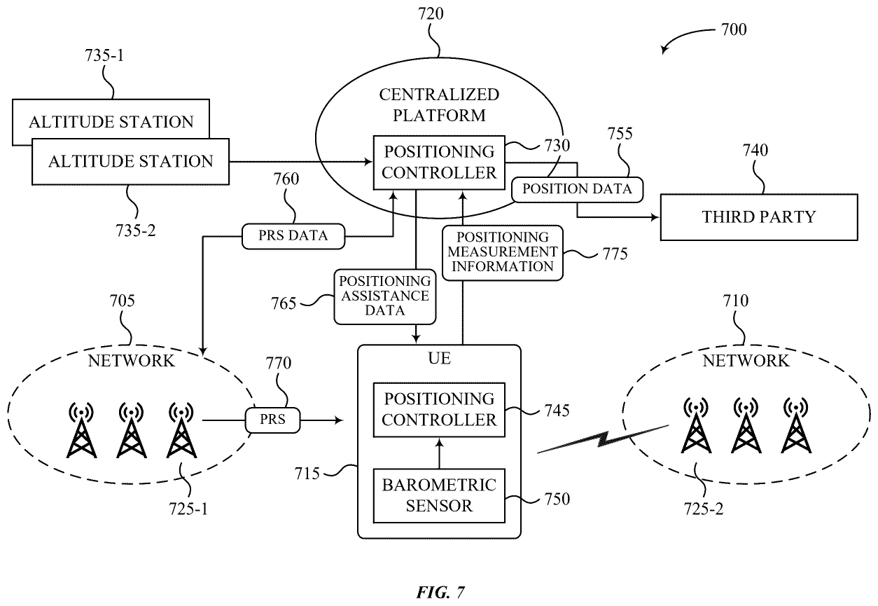

FIG. 7 illustrates an example of an environment 700 that supports open PNT, in accordance with one or more implementations described herein. The environment 700 may implement aspects, devices, or operations as described with reference to FIGS. 1 and 6. For example, the environment may include a network 705 and a network 710, which may be examples of a network 100 and/or a network 600. Likewise, the environment may include a UE 715, which may be an example of a UE 120. Additionally, the environment may include a centralized platform 720, which may be an example of a centralized platform 130.

As shown in FIG. 7, the environment 700 may include aspects or devices of one or more wireless communications systems, such as networks (e.g., network 705, network 710) and UE 715. Additionally, the environment 700 may include a centralized platform 720 configured to communicate with the networks and the UEs 715. The environment 700 may support open PNT, in which a network (e.g., network 705) operable to provide positioning services (e.g., terrestrial PNT) may be configured to provide the positioning services to a UE 715 not registered to the network.

The environment 700 may include the network 705 and the network 710, where the network 705 and the network 710 may each be an example of a mobile network operator. The network 705 and the network 710 may each include one or more devices configured to support wireless communications including network entities 110, such as base stations, next generation NodeBs (gNBs), and transmission reception points (TRPs). For example, FIG. 7 illustrates the network 705 and the network 710 each including TRPs 725, which may be otherwise implemented as network entities 110 (e.g., base stations or gNBs).

In some cases, the network 705 and the network 710 may each be configured to support registration of a UE 715, such that when a UE 715 is registered to the respective network, the respective network may support wireless communications of the UE 715. For example, if a UE 715 is registered to the network 705, the network 705 may provide support for wireless communications of the UE 715. Whereas, if a UE 715 is registered to the network 710, the network 710 may provide support for wireless communications of the UE 715. In some cases, the UE 715 may be registered to one of the networks at a time, such that when a UE 715 is registered to the network 705, the network 710 may not support wireless communications for the UE 715 (e.g., or vice versa). In some such cases, the TRPs 725 associated with each network may provide wireless communications for the UEs 715 registered to the respective network. For example, the TRPs 725 associated with the network 705 may support wireless communications for the UEs 715 registered to the network 705, however not for the UEs registered to the network 710.

In some cases, each TRP 725 may be associated with one or more cells configured to provide wireless communications for a UE 715 within a coverage area of the one or more cells and registered to the network associated with the respective TRP 725. For example, a TRP 725 may be associated with or include a serving cell of the UE 715 based on the UE 715 being within a coverage area of the TRP 725, and the UE 715 being registered to the network associated with the TRP 725. In some cases, the network 705 and the network 710 may be implemented in an at least partially overlapping geographical region. For example, the UE 715 may be within a coverage area of multiple TRPs 725 each associated with either the network 705 or the network 710, however the UE 715 may be registered to the network 705 (e.g., or the network 710) and may therefore use the TRPs 725 associated with the network 705 for wireless communications.

Additionally, the network 705 may be configured to provide positioning services including terrestrial PNT services. In some cases, base stations, gNBs, and TRPs associated with the network 705 may be configured to facilitate transmitting and receiving signaling (position data 755, PRS data 760, positioning assistance data 765, PRS 770) associated with supporting the positioning services. For example, a TRP 725-1 may be configured to support the positioning services based on the TRP 725-1 being associated with the network 705. In some implementations, the network 705 may be otherwise understood to be a positioning enabled network or a positioning enabled mobile network operator. The network 710 may not be configured to provide positioning services, including the terrestrial PNT services. Thus, a TRP 725-2 may not be configured to support the positioning services based on the TRP 725-2 being associated with the network 710. In some implementations, the network 710 may be otherwise understood to be a standard network configured to support wireless communications.

In some cases, the network 705 may be configured to transmit positioning reference signals 770 to the UE 715 in support of providing positioning services to the UE 715. In some cases, the positioning reference signals 770 may be received at the UE 715 and used to perform measurements for determining location information data associated with the UE 715. For example, the UE 715 may use the positioning reference signals 770 to determine location information data or a location of the UE 715, which may be transmitted to the centralized platform 720.

The environment 700 may include the centralized platform 720, which may be configured to communicate with the networks (e.g., the network 705) and the UE 715. The centralized platform 720 may include one or more computing devices and/or one or more servers, and may be otherwise understood to be a centralized positioning platform. In some cases, the centralized platform 720 may be hosted on a public cloud accessible to UEs 715 and networks through a secure connection. The centralized platform 720 may include a positioning controller 730 configured to provide positioning computation services. In some cases, the positioning controller 730 may include one or more components configured to perform or facilitate operations for the centralized platform 720, including receiving and transmitting signaling.

For example, the centralized platform 720 may be configured to support the positioning services of the network 705. That is, the centralized platform 720 may perform operations associated with the network 705 and/or the UE 715 to facilitate providing the positioning services to the UE 715, such as collecting PRS configurations (e.g., PRS data 760), providing assistance data 765, and executing positioning calculations. In some examples, the centralized platform 720 may act as a single point of contact for receiving location requests for UEs 715. In some cases, the centralized platform 720 may be configured to support providing the positioning services to the UE 715 whether the UE 715 is registered to the network 705 or the network 710. In some such cases, the centralized platform 720 may communicate with the network 705 to support providing the positioning services to the UE 715 if the UE 715 is registered to the network 710. The centralized platform 720 may enable UEs 715 registered to the network 705 or the network 710 to be registered with the centralized platform 720.

The environment 700 may include altitude stations 735 (e.g., altitude station 735-1, altitude station 735-2) configured to communicate with the centralized platform 720. In some cases, the altitude stations 735 may be examples of altitude stations 140. The altitude stations 735 may each be configured to provide indications of an altitude of the respective altitude station 735. In some cases, the indications of the altitude may include a measurement of an elevation of the respective altitude station 735 or a measurement of a barometric pressure at the respective altitude station 735. In some examples, the altitude stations 735 may be implemented throughout a geographical region, including at similar or different altitudes. Although FIG. 7 illustrates two altitude stations 735, it should be understood that a different quantity of altitude stations 735 (e.g., less than two altitude stations 735, more than two altitude stations 735) may be implemented.

The environment 700 may include a third party 740 configured to communicate with the centralized platform 720. In some cases, the third party 740 may also be configured to communicate with the UE 715. The third party 740 may be an example of an application or a vendor and may be configured to request location information (e.g., position data 755) associated with the UE 715. For example, the third party 740 may be configured to request the location of the UE 715 from the centralized platform 720 (e.g., from the positioning controller 730).

The environment 700 may include the UE 715, which may be registered to either the network 705 or the network 710. The UE 715 may include a positioning controller 745 configured to provide positioning computation services. In some cases, the positioning controller 745 may include one or more components configured to perform or facilitate operations for the UE 715, include receiving and transmitting signaling. For example, the positioning controller 745 may be configured to support the positioning services of the network 705. The UE 715 may also include a barometric sensor 750 configured to measure a barometric pressure of the UE 715 and provide an indication of the barometric pressure. The UE 715 may be configured to transmit the indication of the barometric pressure to the centralized platform 720 for determining a location of the UE 715, including an altitude or elevation of the UE 715.

FIG. 7 also illustrates operations associated with the environment 700, including signaling between the devices of the environment 700. The signaling shown in FIG. 7 is associated with providing the positioning services to the UE 715. In a first scenario, the UE 715 may be registered to the network 705, which may support the positioning services. However, in a second scenario, the UE 715 may be registered to the network 710, which may not support the positioning services. Thus, the UE 715 may communicate with the centralized platform 720 to receive the positioning services (e.g., positioning assistance data 765) from the network 705, despite the UE 715 not being registered to the network 705.

In the first scenario, the centralized platform 720 may receive a location request for the UE 715 from the third party 740. The centralized platform 720 may store information indicating configuration information associated with the network 705 prior to receiving the location request, which the centralized platform 720 may use for completing the location request. Likewise, the UE 715 may be registered to the centralized platform 720 and the network 705 prior to receiving the location request. After receiving the request, the centralized platform 720 may request information regarding capabilities and the serving cell associated with the UE 715. Then, the centralized platform 720 may generate positioning assistance data 765 for the UE 715 and transmit the positioning assistance data 765 to the UE 715, along with the location request. The positioning assistance data 765 may be based on the configuration information associated with the network 705 and may indicate which TRPs 725 may transmit PRSs 770 to the UE 715 based on a serving cell of the UE 715. For example, if the UE 715 is associated with a serving cell of the TRP 725-1, the positioning assistance data 765 may provide an indication of the PRSs 770 transmitted from the TRP 725-1. Additionally, the positioning assistance data 765 may indicate transmission parameters (e.g., frequency, timing) of the PRSs 770, such that upon receiving the positioning assistance data 765, the UE 715 may be configured to receive the PRSs 770 from the TRPs 725.

After receiving the positioning assistance data 765, the UE 715 may communicate with the TRP 725-1 to determine one or more measurement gaps associated with the serving cell. The measurement gaps may be durations associated with idle or inactive operations or signaling, and may be preconfigured by the network 705 or the respective TRP 725. The UE 715 may use the configuration of the measurement gaps for receiving the PRSs 770 and performing measurements using the PRSs, such that the PRSs 770 are received and measured during the measurement gaps. The UE 715 may receive the PRSs 770 from the TRP 725-1 (e.g., and other TRPs 725 of the network 705) as part of a downlink transmission or broadcast. The UE 715 may use the PRSs 770 to determine location information (e.g., measurement reports) or the location of the UE 715. After determining the location information or the location, the UE 715 may transmit the location information or an indication of the location of the UE 715 to the centralized platform 720 (e.g., as positioning measurement information 775). The centralized platform 720 may transmit the location of the UE 715 to the third party 740 or compute the location of the UE 715 based on indication of location information received from the UE 715 and transmit the location of the UE 715 to the third party 740, to fulfil the location request. The indication of the location of the UE 715 may be included in position data 755.

In the second scenario, the centralized platform 720 may receive a location request for the UE 715 from the third party 740. The centralized platform 720 may store information indicating configuration information associated with the network 705 and the network 710 prior to receiving the location request, which the centralized platform 720 may use for completing the location request. Likewise, the UE 715 may be registered to the centralized platform 720 and the network 710 prior to receiving the location request, despite the UE 715 not being registered to the network 705. After receiving the request, the centralized platform 720 may request information regarding capabilities and the serving cell associated with the UE 715. Then, the centralized platform 720 may generate positioning assistance data 765 for the UE 715 and transmit the positioning assistance data 765 to the UE 715, along with the location request. The positioning assistance data 765 may be based on the configuration information associated with the network 705 and the network 710, and may indicate which TRPs 725 may transmit PRSs 770 to the UE 715 based on a serving cell of the UE 715.

That is, the centralized platform 720 may determine the serving cell of the UE 715 associated with the network 710 and map the serving cell to TRPs 725 of the network 705. For example, if the UE 715 is associated with a serving cell of the TRP 725-2, the positioning assistance data 765 may provide an indication of the PRSs 770 transmitted from the TRP 725-1 of the network 705 based on the TRP 725-1 being in a similar geographical location of the TRP 725-2. Additionally, the positioning assistance data 765 may indicate transmission parameters (e.g., frequency, timing) of the PRSs 770 from the TRP 725-1, such that upon receiving the positioning assistance data 765, the UE 715 may be configured to receive the PRSs 770 from the TRPs 725-1.

After receiving the positioning assistance data 765, the UE 715 may communicate with the TRP 725-2 to determine one or more measurement gaps associated with the serving cell. The UE 715 may use the configuration of the measurement gaps for receiving the PRSs 770 and performing measurements using the PRSs 770, such that the PRSs 770 are received and measured during the measurement gaps. The UE 715 may receive the PRSs 770 from the TRP 725-1 (e.g., and other TRPs 725 of the network 705) as part of a downlink transmission or broadcast, despite the UE 715 not being registered to the network 705 (e.g., associated with the TRP 725-1). The UE 715 may use the PRSs 770 to determine location information or the location of the UE 715. After determining the location information or the location, the UE 715 may transmit the location information or an indication of the location of the UE 715 to the centralized platform 720. The centralized platform 720 may transmit the location of the UE 715 to the third party 740 or compute the location of the UE 715 based on indication of location information received from the UE 715 and transmit the location of the UE 715 to the third party 740 (e.g., using position data 755), to fulfil the location request.

In some cases, the centralized platform 720 may additionally implement a coarse position estimate to facilitate reduced time for determining the location of the UE 715. For example, the centralized platform 720 may receive a coarse position estimate (e.g., a rough estimation of the location) of the UE 715 from the network 710 to support identifying the serving cell of the UE 715 for generating the positioning assistance data 765. That is, the coarse position estimate may be used to identify TRPs 725 associated with the UE 715. In some such examples, receiving the coarse position estimate may reduce the search for PRSs with sliding fast Fourier transform (FFT) symbol time window due to approximate distances to TRPs 725 being used to provide assistance to reduce the time window search for FFT. In some examples, the coarse position estimate may be used to determine the positioning assistance data 765 based on the TRPs 725 associated with the UE 715. In some implementations, the centralized platform 720 may optimize a quantity of TRPs 725 associated with a coarse position estimate based on building a learnt database of TRPs 725 in a given area. Implementing the coarse position estimate may support search optimization of the PRSs 770 by the UE 715 and aid in selecting the TRPs 725 for improved performance of the positioning services.

In some cases, a timing between the network 705 and the network 710 may be offset. For example, a subframe timing of the network 710 may be offset from the network 705. In some such cases, timing offset between the networks may cause difficulty for the UE 715 to receive the PRSs 770 from the network 705 while being registered to the network 710 (e.g., the second scenario). However, the UE 715 and/or the centralized platform 720 may implement mitigation strategies for aligning the timing at the UE 715, such that the UE 715 may accurately and reliably receive the PRSs 770.

For example, timing of signaling associated with the network 710 may be used to determine timing of the network 705. In some implementations, if the timing between the networks is at least coarsely synchronized (e.g., for subframe alignment), then the timing of reference or data signaling by the network 710 may be used by the UE 715 to determine timing of the network 705. In some such implementations, the reference or data signaling may include a primary synchronization signal (PSS), a second synchronization signal (SSS), a physical broadcast channel (PBCH), or a cell-specific reference signal (CRS). In other examples, the centralized platform 720 may identify information regarding the timing offset between the networks and transmit an indication of the timing offset to the UE 715. For example, the centralized platform 720 may use crowd sourced data from UEs 715 registered to the centralized platform or separate devices that are configured to identify signaling from both networks to determine the timing offset. After the UE 715 has an indication of the timing offset between the networks, the UE 715 may use the timing offset to adjust for receiving the PRSs 770 from the network 705.

Additionally, or alternatively, frequencies for signaling of each network may be different. That is, a frequency of the network 710 may be offset from a frequency of the network 705, which may cause difficulty for the UE 715 to receive the PRSs 770 from the network 705 while being registered to the network 710 (e.g., the second scenario). However, the UE 715 and/or the centralized platform 720 may implement mitigation strategies for determining the frequency of the network 705, such that the UE 715 may accurately and reliably receive the PRSs 770. For example, a frequency associated with signaling of the network 710 may be used by the UE 715 to determine a frequency of the network 705. In some such examples, the signaling may include a PSS, an SSS, a PBCH, a demodulation reference signal (DMRS), or control channel signals (e.g., a physical downlink control channel (PDCCH), a physical downlink shared channel (PDSCH)). In other examples, the frequency of the network 705 may be extracted by the UE 715 from signaling of the network 705, including PSSs, SSSs, or PBCHs. After the UE 715 has an indication of the frequency offset between the networks, the UE 715 may use the frequency offset to adjust for receiving the PRSs 770 from the network 705. In some cases, the UE 715 may benefit from increased efficiency based on directly measuring the signaling of the network 705 or the network 710 rather than receiving an indication thereof.

In both the first scenario and the second scenario, the location of the UE 715 may be determined relative to both the geographical plane (e.g., extending along both an x-axis and a y-axis) and altitude (e.g., extending along a z-axis). That is, the PRSs 770 may enable the location of the UE 715 to be determined relative to the geographical plane, and the barometric sensor 750 and the altitude stations 735 may be used to enable the location of the UE 715 to be determined relative to altitude. For example, the barometric sensor 750 may measure a barometric pressure of the UE 715, and the UE 715 may transmit an indication of the barometric pressure to the centralized platform 720. Likewise, the altitude stations 735 may transmit indications of altitudes and/or barometric pressure of the altitude stations 735 to the centralized platform 720. The centralized platform 720 may compare the barometric pressure received from the UE 715 with the indications received from the altitude stations 735 to determine the location of the UE 715 relative to altitude or elevation. In some cases, when fulfilling a location request, the centralized platform 720 may include the location of the UE 715 relative to both the geographical plane and altitude. In some such cases, the location request may be an exact location of the UE 715 rather than an approximate location or a solely geographical location.

The environment 700 illustrates implementations in which the UE 715 may be registered to either the network 705 or the network 710. In accordance with examples as described herein, the network 705 may be configured to provide the positioning services, including terrestrial PNT, to the UE 715 despite the UE 715 being registered to the network 710, which is not configured to provide the positioning services. Thus, the environment 700 supports providing positioning services to UEs 715 served by different networks (e.g., mobile carriers). By using PRSs 770 broadcast (e.g., in a standardized frequency band) from TRPs 725 associated with the network 705, UEs 715 that are subscribed (e.g., registered) or not may be able to access the positioning services provided by the network 705. Implementing the environment 700 as shown in FIG. 7 may therefore support accurate and resilient positioning services to UEs 715 regardless of the registration of the UEs 715 (e.g., to the network 705 or the network 710).

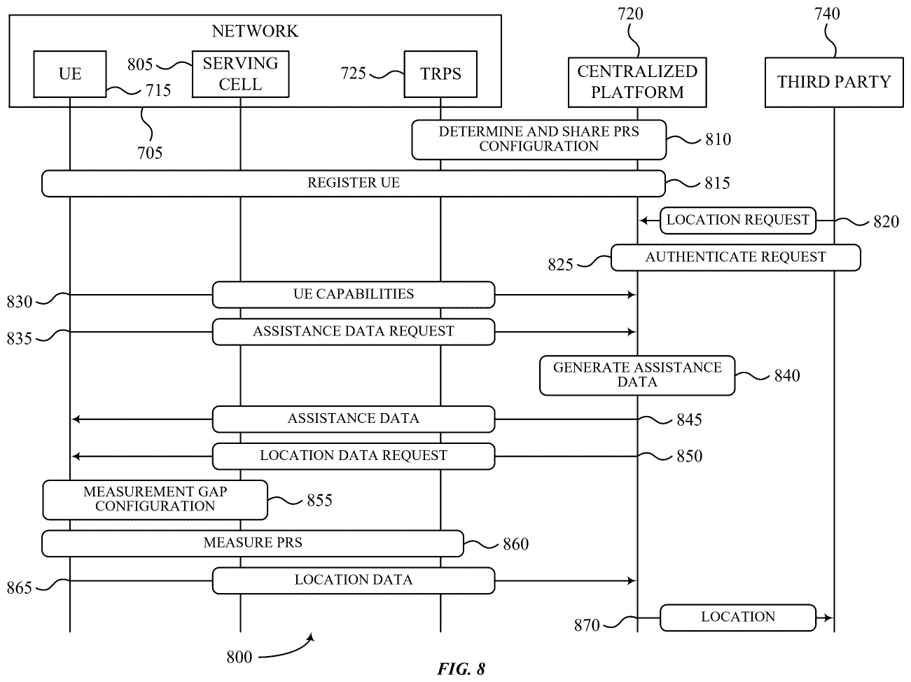

FIG. 8 illustrates an example of a process 800 that supports open PNT, in accordance with one or more implementations described herein. As shown, the process 800 may implement aspects or operations of the environment 700 as described with reference to FIG. 7. For example, operations of the process 800 may be performed by a network 705, a centralized platform 720, and a third party 740. In some cases, operations described as being associated with the network 705 may be performed by devices of the network 705, including a UE 715, a serving cell 805, and one or more TRPs 725. In some implementations, operations described as being associated with the UE 715 may be performed, at least in part, by baseband circuitry of the UE 715, or a positioning controller (e.g., a positioning controller 745) and a barometric sensor (e.g., a barometric sensor 750). In some implementations, operations described as being associated with the centralized platform 720 may be performed, at least in part, by a positioning controller (e.g., a positioning controller 730) and one or more altitude stations (e.g., altitude stations 735). In some implementations, the serving cell 805 may be a cell configured to provide coverage to the UE 715 in a coverage area of the cell. Likewise, the serving cell 805 may be associated with a TRP 725, a base station, a gNB, or another type of network access point of the network 705.

Some or all of the operations of the process 800 may be performed by one or more other systems or devices, including one or more devices shown and described with reference to FIG. 7. Additionally, or alternatively, the process 800 may include one or more additional, fewer, differently order, and/or arranged operations than those shown in FIG. 8. Some or all of the operations of the process 800 may be performed independently, successively, simultaneously, etc., of one or more of the other operations of the process 800. As such, the techniques described herein are not limited to the number, sequence, arrangement, timing, etc., of the operations or process depicted in the FIG. 8. The process 800 may be associated with the first scenario described with reference to FIG. 7. For example, the process 800 depicts operations associated with providing positioning services, including terrestrial PNT, to a UE 715 registered to the network 705, which is configured to provide the positioning services.

As shown in the process 800, a PRS configuration may be determined and shared between the network 705 and the centralized platform 720 (block 810). For example, the network 705 may configure the PRSs to be transmitted from the TRPs 725, including configuring a frequency, a timing, and a periodicity for transmitting the PRSs. Likewise, the network 705 may determine which TRPs 725 may be configured to transmit the PRSs. The network 705 may share the PRS configuration with the centralized platform 720, including the frequency, timing, and periodicity for transmitting the PRSs from the TRPs 725, and an indication of the TRPs 725 associated with transmitting the PRSs. In some examples, the network 705 may also share an indication of the TRPs 725 associated with the network 705, regardless of whether the TRPs 725 are associated with transmitting the PRSs. In some cases, the centralized platform 720 may request the PRS configuration from the network 705, and the network 705 may fulfil the request based on transmitting an indication of the PRS configuration and the TRPs 725. In other cases, the network 705 may transmit an indication of the PRS configuration and the TRPs 725 automatically to the centralized platform 720, without a request from the centralized platform 720 (e.g., in accordance with a reporting schedule). After receiving the indication of the PRS configuration and the TRPs 725, the centralized platform 720 may store the indication of the PRS configuration and the TRPs 725.

As shown in the process 800, the UE 715 may be registered to the network 705 and the centralized platform 720 (block 815). For example, the UE 715 may be registered to the network 705, such that the UE 715 may be configured to receive the positioning services from the network 705. Likewise, the UE 715 may be registered to the centralized platform 720, such that the centralized platform 720 may be configured to facilitate the network 705 providing the positioning services to the UE 715. In some cases, the UE 715 may be registered to the network 705 and the centralized platform 720 prior to performing the operations of the process 800.

In some cases, the UE 715 may be configured to communicate with the centralized platform 720 using an over-the-top data transmission method based on being registered to the centralized platform 720 and/or the network 705. For example, the UE 715 may communicate with the centralized platform 720 using internet protocols that are independent of traditional telecom carriers' control, such that data is delivered directly to the UE 715 without interfacing with the carrier's dedicated network operations or control mechanisms. In some examples, the UE 715 may be configured to communicate with the centralized platform 720 using LTE positioning protocol (LLP) over secure user plane location (SUPL), location-based services user plane positioning (LCS UPP), or a control plane (e.g., the 5G control plane). In some implementations, the UE 715 may communicate with the centralized platform 720 using a data or control plane associated with the network 705.

As shown in the process 800, the centralized platform 720 may receive a location request from the third party 740 (block 820). The location request may be for a location of the UE 715. In some cases, the centralized platform 720 may receive the location request for each UE 715 registered to the centralized platform 720, such that the centralized platform is a single contact for location requests. In some cases, the third party 740 may be an example of an application requesting the location of the UE 715.

As shown in the process 800, the centralized platform 720 may authenticate the location request received from the third party 740 (block 825). For example, the centralized platform 720 may determine a validity of the location request or a validity of the third party 740 to verify the location request. In some examples, the centralized platform 720 may determine the location request and the third party 740 are valid (e.g., satisfy a validity threshold or determination), and authorize the location request. In some such examples, the process 800 may continue to the next step (block 830) of the process 800. However, in other examples, the centralized platform 720 may determine the location request and/or the third part 740 are invalid (e.g., fail to satisfy a validity threshold or determination), and refrain from authorizing the location request. In some such examples, the process 800 may not continue to the next step (block 830) of the process 800, and the process 800 may be paused until another location request is received from the third party 740.

As shown in the process 800, capabilities of the UE 715 may be communicated between the UE 715 and the centralized platform 720 (block 830). The capabilities of the UE 715 may include a compatibility of the UE 715 for performing the location request, or a compatibility of the UE 715 for using the positioning services provided by the network 705. Additionally, or alternatively, the capabilities of the UE 715 may include an indication of the serving cell 805 associated with the UE 715. For example, the UE 715 may be within a coverage area of the serving cell 805 (e.g., associated with a TRP 725), and the UE capabilities may include an indication of the TRP 725 associated with the serving cell. In some examples, the serving cell 805 of the UE 715 may be indicated in the assistance data request from UE 715. In some cases, the centralized platform 720 may request the UE capabilities from the UE 715, and in response to receiving the request, the UE 715 may transmit an indication of the UE capabilities to the centralized platform 720. In some such cases, the centralized platform 720 may request the UE capabilities based on receiving the location request at block 820. In other cases, the UE 715 may transmit the indication of the UE capabilities to the centralized platform 720 in accordance with a reporting frequency, or based on changing serving cells (e.g., or other UE capability changes). In some examples, the UE 715 may transmit the indication of the UE capabilities to the centralized platform 720 based on the location request (e.g., based on receiving an indication of the location request from the centralized platform 720).

In some cases, the network 705 may provide an indication of the serving cell 805 to the centralized platform 720. That is, the network 705 may transmit an indication of the TRPs 725 supported by the network 705, including an indication of the serving cell 805 to the centralized platform 720. In some such cases, the network 705 may transmit the indication of the serving cell 805 as part of a reporting schedule or based on receiving an indication of the location request from the centralized platform 720.

As shown in the process 800, the UE 715 may transmit an assistance data request to the centralized platform 720 (block 835). For example, the UE 715 may transmit a request for assistance data associated with facilitating the positioning services of the network 705. In some cases, the assistance data request may include a request for TRPs 725 of the network 705 associated with transmitting PRSs, and a request for a PRS configuration of the TRPs 725. In some examples, the UE 715 may transmit the assistance data request to the centralized platform 720 in accordance with a reporting frequency, or based on changing serving cells (e.g., or other UE capability changes). In other examples, the UE 715 may transmit the assistance data request to the centralized platform 720 based on the location request (e.g., based on receiving an indication of the location request from the centralized platform 720). Likewise, the UE 715 may transmit the assistance data request to the centralized platform 720 based on receiving the request for the UE capabilities from the centralized platform 720.

As shown in the process 800, the centralized platform 720 may generate the assistance data based on receiving the assistance data request (block 840). The centralized platform 720 may generate the assistance data based on the PRS configuration stored during block 810 and the UE capabilities received at block 830. For example, the assistance data may include an indication of TRPs 725 associated with the UE 715 and configured to transmit PRSs to the UE 715, based on the serving cell 805 of the UE 715. Likewise, the assistance data may include an indication of the frequency, timing, and periodicity of the PRSs transmitted by the TRPs 725, such that upon receiving the assistance data, the UE 715 may be configured to receive the PRSs accordingly. In some cases, to generate the assistance data, the centralized platform 720 may compare the serving cell 805 of the UE 715 (e.g., indicated by the received UE capabilities) to the TRPs 725 associated with the network 705 to determine which TRPs 725 the UE 715 should use for receiving the PRSs. In some examples, the serving cell 805 of the UE 715 may be indicated in the assistance data request from UE 715. For example, the centralized platform 720 may determine a subset of the TRPs 725 are associated with (e.g., nearby) the serving cell 805, and the centralized platform 720 may generate the assistance data to include an indication of the subset of the TRPs 725.

As shown in the process 800, the centralized platform 720 may transmit the assistance data to the UE 715 (block 845). In some cases, the centralized platform 720 may transmit the assistance data to the UE 715 using an over-the-top data transmission method. For example, the assistance data may be transmitted using an over-the-top data transmission based on the UE 715 being registered to the network 705. However, in other cases, the centralized platform 720 may transmit the assistance data to the UE 715 using a data plane or control plane associated with the network 705. The centralized platform 720 may transmit the data based on generating the assistance data, which may be in response to the centralized platform 720 receiving the request for the assistance data from the UE 715.

As shown in the process 800, the centralized platform 720 may transmit a location data request to the UE 715 (block 850). In some cases, the location data request may be a request for location data associated with the location of the UE 715, including measurement reporting based on the PRSs. In some such cases, the centralized platform 720 may transmit such a request based on determining that the UE 715 may not have a capability to determine the location using the location data. For example, the UE capabilities may indicate that the UE 715 may not be configured to determine the location based on receiving the PRSs, thus the request may be for the location data rather than the location of the UE 715. In other cases, the location data request may be a request for the location of the UE 715. In some such cases, the centralized platform 720 may transmit such a request based on determining that the UE 715 may have the capability to determine the location using the location data (e.g., based on receiving the PRSs).

As shown in the process 800, the UE 715 may communicate with the serving cell 805 or the network 705 to determine a measurement gap configuration (block 855). The measurement gap configuration may include an indication of preconfigured or expected measurement gaps of the serving cell 805 or the network 705. For example, the measurement gap configuration may include an indication of measurement gaps of the TRPs 725 associated with the network 705. The measurement gaps may be preconfigured or expected durations of inactivity or experienced durations of inactivity, in which the serving cell 805 (e.g., or the network 705, the TRPs 725) are not configured to transmit (e.g., or receive) signaling. In some cases, the measurement gaps may be durations in which a level of activity or a quantity of operations performed satisfies one or more thresholds.

In some cases, the UE 715 may request an indication of the measurement gap configuration from the network 705 (e.g., the serving cell 805). For example, the UE 715 may request the indication of the measurement gap configuration based on receiving the location data request or based on receiving the assistance data from the centralized platform 720. In some implementations, the UE 715 may request a start time and a stop time for each of the measurement gaps. For example, the UE 715 may use a network specific request such as a radio resource control (RRC) location measurement indication message to request a start time and a stop time for the measurement gaps. In some implementations, the UE 715 may indicate to the network 705 when to perform the measurement gaps, including an indication of a start time and a stop time for each measurement gap. For example, if measurement gaps are not available, wireless communication and/or operations of the network 705 may be temporarily paused or terminated to provide the measurement gaps. That is, the UE 715 may request the network 705 to pause or terminate the wireless communications and/or operations; or the network 705 may pause or terminate the wireless communications and/or operations. In some such cases, the network 705 (e.g., the serving cell 805) may determine (e.g., identify) the measurement gap configuration and transmit the indication of the measurement gap configuration (e.g., from the serving cell 805) to the UE 715. After receiving the indication of the measurement gap configuration, the UE 715 may store (e.g., load for future use) the indication of the measurement gap configuration. In some cases, after storing the indication of the measurement gap configuration, the UE 715 may transmit a completion message to the network 705 (e.g., the serving cell 805), indicating that the UE 715 has received the measurement gap configuration. In some cases, the UE 715 may not request an indication of the measurement gap configuration and may instead perform receive and perform measurements using the PRSs during durations of inactivity experienced at the UE 715.

As shown in the process 800, the UE 715 may receive the PRSs from the TRPs 725 and perform measurements using the PRSs (block 860). The UE 715 may receive the PRSs during the measurement gaps indicated in the measurement gap configuration. For example, the UE 715 may use the stored indication of the measurement gap configuration to determine when the measurement gaps of the serving cell 805 will be, and the UE 715 may receive the PRSs from the TRPs 725 of the network 705 during the measurement gaps. In some cases, to receive the PRSs, the UE 715 may search for the PRSs from the TRPs 725 based on the assistance data received at block 845. That is, the assistance data may indicate which TRPs 725 of the network 705 to use for receiving the PRSs and a configuration of the PRSs from the TRPs 725. The UE 715 may use the assistance data to search for the PRSs from the TRPs 725 at a frequency, timing, and periodicity indicated by the assistance data. In some examples, the PRSs may be broadcast to the UE 715 using a broadcast channel associated with the network 705.

After receiving the PRSs from the TRPs 725, the UE 715 may use the PRSs to perform measurements for determining location data associated with the UE 715. That is, the UE 715 may use (e.g., compare) the PRSs to perform measurements, the results of which may be used to determine the location data associated with the UE 715. In some cases, the UE 715 may perform the measurements using the PRSs during the measurement gaps. In some examples, after performing the measurements, the UE 715 may transmit an indication to the serving cell 805 or the network 705 (e.g., the TRPs 725) that the measurements have been completed.

In some cases, performing the measurements may include determining the barometric pressure at the UE 715. For example, the barometric sensor (e.g., the barometric sensor 750) of the UE 715 may determine the barometric pressure based on an altitude of the UE 715.

As shown in the process 800, the UE 715 may transmit location data to the centralized platform 720 (block 865). In some cases, the location data may be the location data (e.g., PRS measurements) determined at block 860 as a result of performing the measurements. That is, the location data may be the raw information or measurement reporting associated with the PRSs received from the TRPs 725. In other cases, the location data may be an indication of the location of the UE 715. For example, the UE 715 may be configured to determine the location (e.g., an exact location) of the UE based on the location data determined at block 860. In some examples, the UE 715 may transmit the location data as the location data (e.g., PRS measurements) determined at block 860 based on the centralized platform 720 indicating to transmit the location data accordingly in the location data request received at block 850. However, in other examples, the UE 715 may transmit the location data as the indication of the location based on the centralized platform 720 indicating to transmit the location accordingly in the location data request received at block 850. In some examples, the location data may also include the barometric pressure of the UE 715.

As shown in process 800, the centralized platform 720 may transmit the location of the UE 715 to the third party 740 (block 870). In some cases, if the UE 715 transmitted the location data as the indication of location of the UE 715, the centralized platform 720 may forward the indication of the location from the UE 715 to the third party 740. In other cases, if the UE 715 transmitted the location data as the location data (e.g., PRS measurements) determined at block 860, the centralized platform 720 may determine the location of the UE 715 using the location data, and transmit an indication of the location to the third party 740. That is, if the UE 715 is configured to determine the location from the PRSs, the UE 715 may transmit the location to the centralized platform 720, and the centralized platform 720 may transmit the location to the third party 740. However, if the UE 715 is not configured to determine the location from the PRSs, the UE 715 may transmit the location data (e.g., PRS measurements) to the centralized platform 720, and the centralized platform 720 may use the location data to determine the location of the UE 715; then, the centralized platform 720 may transmit the location to the third party 740.

In some cases, determining the location of the UE 715 may include determining an altitude of the UE 715. For example, the centralized platform 720 may compare altitude measurements (e.g., altitude readings, barometric pressures) received from one or more altitude stations to the barometric pressure received from the UE 715 to determine an altitude of the UE 715. Thus, the location of the UE 715 transmitted to the third party 740 may include a location of the UE 715 relative to a geographical plane and an altitude.

In accordance with examples as described herein, the process 800 may support the network 705 providing positioning services to the UE 715 registered to the network 705, based on the centralized platform 720 facilitating operations between the network 705 and the UE 715. The process 800 illustrates operations associated with supporting terrestrial PNT as described herein. Additionally, the process 800 includes operations associated with supporting three-dimensional location determination. Implementing the process 800 may enable improved accuracy and resiliency for determining the location of a UE 715.

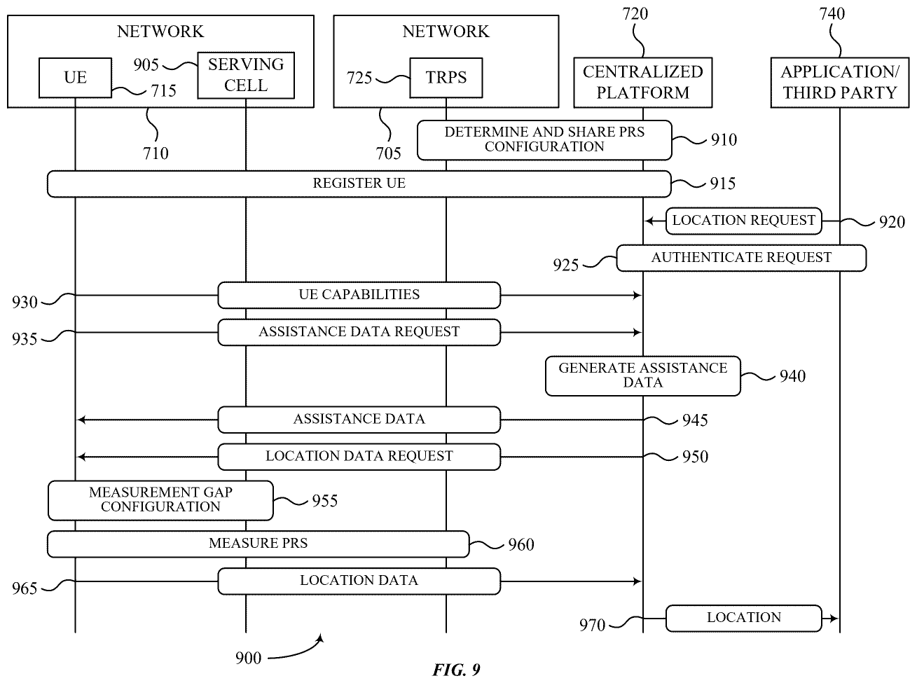

FIG. 9 illustrates an example of a process 900 that supports open PNT, in accordance with one or more implementations described herein. As shown, the process 900 may implement aspects or operations of the environment 700 as described with reference to FIG. 7. For example, operations of the process 900 may be performed by a network 705, a network 710, a centralized platform 720, and a third party 740. In some cases, operations described as being associated with the network 710 may be performed by devices of the network 710, including a UE 715 and a serving cell 905. Likewise, operations described as being associated with the network 705 may be performed by devices of the network 705, such as one or more TRPs 725. In some implementations, operations described as being associated with the UE 715 may be performed, at least in part, by baseband circuitry of the UE 715, or a positioning controller (e.g., a positioning controller 745) and a barometric sensor (e.g., a barometric sensor 750). In some implementations, operations described as being associated with the centralized platform 720 may be performed, at least in part, by a positioning controller (e.g., a positioning controller 730) and one or more altitude stations (e.g., altitude stations 735). In some implementations, the serving cell 905 may be a cell configured to provide coverage to the UE 715 in a coverage area of the cell. Likewise, the serving cell 905 may be associated with a TRP 725, a base station, a gNB, or another type of network access point of the network 710.

Some or all of the operations of the process 900 may be performed by one or more other systems or devices, including one or more devices shown and described with reference to FIG. 7. Additionally, or alternatively, the process 900 may include one or more additional, fewer, differently order, and/or arranged operations than those shown in FIG. 9. Some or all of the operations of the process 900 may be performed independently, successively, simultaneously, etc., of one or more of the other operations of the process 900. As such, the techniques described herein are not limited to the number, sequence, arrangement, timing, etc., of the operations or process depicted in the FIG. 9. The process 900 may be associated with the second scenario described with reference to FIG. 7. For example, the process 900 depicts operations associated with providing positioning services, including terrestrial PNT, to a UE 715 registered to the network 710, which is not configured to provide the positioning services. That is, the network 705 is configured to provide the positioning services to the UE 715, despite the UE 715 not being registered to the network 705.

As shown in the process 900, a PRS configuration may be determined and shared between the network 705 and the centralized platform 720 (block 910). For example, the network 705 may configure the PRSs to be transmitted from the TRPs 725, including configuring a frequency, a timing, and a periodicity for transmitting the PRSs. Likewise, the network 705 may determine which TRPs 725 may be configured to transmit the PRSs. The network 705 may share the PRS configuration with the centralized platform 720, including the frequency, timing, and periodicity for transmitting the PRSs from the TRPs 725, and an indication of the TRPs 725 associated with transmitting the PRSs. In some examples, the network 705 may also share an indication of the TRPs 725 associated with the network 705, regardless of whether the TRPs 725 are associated with transmitting the PRSs. In some cases, the centralized platform 720 may request the PRS configuration from the network 705, and the network 705 may fulfil the request based on transmitting an indication of the PRS configuration and the TRPs 725. In other cases, the network 705 may transmit an indication of the PRS configuration and the TRPs 725 automatically to the centralized platform 720, without a request from the centralized platform 720 (e.g., in accordance with a reporting schedule). After receiving the indication of the PRS configuration and the TRPs 725, the centralized platform 720 may store the indication of the PRS configuration and the TRPs 725.

As shown in the process 900, the UE 715 may be registered to the network 710 and the centralized platform 720 (block 915). For example, the UE 715 may be registered to the network 710, such that the UE 715 may be configured to receive wireless communication services from the network 710. Likewise, the UE 715 may be registered to the centralized platform 720, such that the centralized platform 720 may be configured to facilitate the network 705 providing the positioning services to the UE 715. That is, the UE 715 may not be registered to the network 705. In some cases, the UE 715 may be registered to the network 710 and the centralized platform 720 prior to performing the operations of the process 900.

In some cases, the UE 715 may be configured to communicate with the centralized platform 720 using an over-the-top data transmission method based on being registered to the centralized platform 720 and/or the network 710. For example, the UE 715 may communicate with the centralized platform 720 using internet protocols that are independent of traditional telecom carriers' control, such that data is delivered directly to the UE 715 without interfacing with the carrier's dedicated network operations or control mechanisms. In some examples, the UE 715 may be configured to communicate with the centralized platform 720 using LTE positioning protocol (LLP) over secure user plane location (SUPL), location-based services user plane positioning (LCS UPP), or a control plane (e.g., the 5G control plane). In some implementations, the UE 715 may communicate with the centralized platform 720 using a data or control plane associated with the network 710.

As shown in the process 900, the centralized platform 720 may receive a location request from the third party 740 (block 920). The location request may be for a location of the UE 715. In some cases, the centralized platform 720 may receive the location request for each UE 715 registered to the centralized platform 720, such that the centralized platform is a single contact for location requests. In some cases, the third party 740 may be an example of an application requesting the location of the UE 715.

As shown in the process 900, the centralized platform 720 may authenticate the location request received from the third party 740 (block 925). For example, the centralized platform 720 may determine a validity of the location request or a validity of the third party 740 to verify the location request. In some examples, the centralized platform 720 may determine the location request and the third party 740 are valid (e.g., satisfy a validity threshold or determination), and authorize the location request. In some such examples, the process 900 may continue to the next step (block 930) of the process 900. However, in other examples, the centralized platform 720 may determine the location request and/or the third party 740 are invalid (e.g., fail to satisfy a validity threshold or determination), and refrain from authorizing the location request. In some such examples, the process 900 may not continue to the next step (block 930) of the process 900, and the process 900 may be paused until another location request is received from the third party 740.

As shown in the process 900, capabilities of the UE 715 may be communicated between the UE 715 and the centralized platform 720 (block 930). The capabilities of the UE 715 may include a compatibility of the UE 715 for performing the location request, or a compatibility of the UE 715 for using the positioning services provided by the network 705. Additionally, or alternatively, the capabilities of the UE 715 may include an indication of the serving cell 905 associated with the UE 715. For example, the UE 715 may be within a coverage area of the serving cell 905 (e.g., associated with a TRP 725), and the UE capabilities may include an indication of the TRP 725 associated with the serving cell 905. In other examples, the serving cell 905 of the UE 715 may be indicated in the assistance data request from UE 715. In some cases, the centralized platform 720 may request the UE capabilities from the UE 715, and in response to receiving the request, the UE 715 may transmit an indication of the UE capabilities to the centralized platform 720. In some such cases, the centralized platform 720 may request the UE capabilities based on receiving the location request at block 920. In other cases, the UE 715 may transmit the indication of the UE capabilities to the centralized platform 720 in accordance with a reporting frequency, or based on changing serving cells (e.g., or other UE capability changes). In some examples, the UE 715 may transmit the indication of the UE capabilities to the centralized platform 720 based on the location request (e.g., based on receiving an indication of the location request from the centralized platform 720).

In some cases, the network 710 may provide an indication of the serving cell 905 to the centralized platform 720. That is, the network 710 may transmit an indication of the TRPs 725 supported by the network 710, including an indication of the serving cell 905 to the centralized platform 720. In some such cases, the network 710 may transmit the indication of the serving cell 905 as part of a reporting schedule or based on receiving an indication of the location request from the centralized platform 720.

In some cases, the network 710 may provide a coarse position estimate to the centralized platform 720. That is, the network 710 may transmit an indication of a coarse position estimate of the UE 715, which may be an indication of an approximate location of the UE 715, to the centralized platform 720. In some such cases, the network 710 may transmit the indication of the coarse position estimate as part of a reporting schedule or based on receiving an indication of the location request from the centralized platform 720.

As shown in the process 900, the UE 715 may transmit an assistance data request to the centralized platform 720 (block 935). For example, the UE 715 may transmit a request for assistance data associated with facilitating the positioning services of the network 705. In some cases, the assistance data request may include a request for TRPs 725 of the network 705 associated with transmitting PRSs, and a request for a PRS configuration of the TRPs 725. In some examples, the UE 715 may transmit the assistance data request to the centralized platform 720 in accordance with a reporting frequency, or based on changing serving cells (e.g., or other UE capability changes). In other examples, the UE 715 may transmit the assistance data request to the centralized platform 720 based on the location request (e.g., based on receiving an indication of the location request from the centralized platform 720). Likewise, the UE 715 may transmit the assistance data request to the centralized platform 720 based on receiving the request for the UE capabilities from the centralized platform 720.

As shown in the process 900, the centralized platform 720 may generate the assistance data based on receiving the assistance data request (block 940). The centralized platform 720 may generate the assistance data based on the PRS configuration stored during block 910 and the UE capabilities received at block 930. In some cases, the assistance data may be generated based on receiving the indication of the serving cell 905 from the network 710. In some cases, the assistance data may be generated based on the coarse position estimate of the UE 715. For example, the assistance data may include an indication of TRPs 725 of the network 705 associated with the serving cell 905 of the UE 715, which may be configured to transmit PRSs to the UE 715 based on the UE 715 being in geographical proximity to the TRPs 725 (e.g., identified by the serving cell 905). Likewise, the assistance data may include an indication of the frequency, timing, and periodicity of the PRSs transmitted by the TRPs 725, such that upon receiving the assistance data, the UE 715 may be configured to receive the PRSs accordingly. In some cases, the centralized platform 720 may be configured to determine a timing and/or frequency offset between the network 705 and the network 710. In some such cases, the centralized platform 720 may generate the assistance data to include an indication of the timing and/or frequency offset, such that upon receiving the assistance data, the UE 715 may account for the timing and/or frequency offset for receiving the PRSs from the network 705.

In some cases, to generate the assistance data, the centralized platform 720 may compare the serving cell 905 of the UE 715 (e.g., indicated by the received UE capabilities) to the TRPs 725 associated with the network 705 to determine which TRPs 725 the UE 715 should use for receiving the PRSs. In some examples, the serving cell 905 of the UE 715 may be indicated in the assistance data request from UE 715. For example, the centralized platform 720 may determine a subset of the TRPs 725 (e.g., of the network 705) are associated with (e.g., nearby) the serving cell 905, and the centralized platform 720 may generate the assistance data to include an indication of the subset of the TRPs 725.

As shown in the process 900, the centralized platform 720 may transmit the assistance data to the UE 715 (block 945). In some cases, the centralized platform 720 may transmit the assistance data to the UE 715 using an over-the-top data transmission method. For example, the assistance data may be transmitted using an over-the-top data transmission based on the UE 715 being registered to the network 710 (e.g., and not registered to the network 705). The centralized platform 720 may transmit the data based on generating the assistance data, which may be in response to the centralized platform 720 receiving the request for the assistance data from the UE 715.

As shown in the process 900, the centralized platform 720 may transmit a location data request to the UE 715 (block 950). In some cases, the location data request may be a request for location data associated with the location of the UE 715, including measurement reporting based on the PRSs. In some such cases, the centralized platform 720 may transmit such a request based on determining that the UE 715 may not have a capability to determine the location using the location data. For example, the UE capabilities may indicate that the UE 715 may not be configured to determine the location based on receiving the PRSs, thus the request may be for the location data rather than the location of the UE 715. In other cases, the location data request may be a request for the location of the UE 715. In some such cases, the centralized platform 720 may transmit such a request based on determining that the UE 715 may have the capability to determine the location using the location data (e.g., based on receiving the PRSs).

As shown in the process 900, the UE 715 may communicate with the serving cell 905 or the network 710 to determine a measurement gap configuration (block 955). The measurement gap configuration may include an indication of preconfigured or expected measurement gaps of the serving cell 905 or the network 710. For example, the measurement gap configuration may include an indication of measurement gaps of the TRPs 725 associated with the network 710. The measurement gaps may be preconfigured or expected durations of inactivity or experienced durations of inactivity, in which the serving cell 905 (e.g., or the network 710, the TRPs 725) are not configured to transmit (e.g., or receive) signaling. In some cases, the measurement gaps may be durations in which a level of activity or a quantity of operations performed satisfies one or more thresholds.

In some cases, the UE 715 may request an indication of the measurement gap configuration from the network 710 (e.g., the serving cell 905). For example, the UE 715 may request the indication of the measurement gap configuration based on receiving the location data request or based on receiving the assistance data from the centralized platform 720. In some implementations, the UE 715 may request a start time and a stop time for each of the measurement gaps. For example, the UE 715 may use a network specific request such as a radio resource control (RRC) location measurement indication message to request a start time and a stop time for the measurement gaps. In some implementations, the UE 715 may indicate to the network 710 when to perform the measurement gaps, including an indication of a start time and a stop time for each measurement gap. For example, if measurement gaps are not available, wireless communication and/or operations of the network 710 may be temporarily paused or terminated to provide the measurement gaps. That is, the UE 715 may request the network 710 to pause or terminate the wireless communications and/or operations; or the network 710 may pause or terminate the wireless communications and/or operations. In some such cases, the network 710 (e.g., the serving cell 905) may determine (e.g., identify) the measurement gap configuration and transmit the indication of the measurement gap configuration (e.g., from the serving cell 905) to the UE 715. After receiving the indication of the measurement gap configuration, the UE 715 may store (e.g., load for future use) the indication of the measurement gap configuration. In some cases, after storing the indication of the measurement gap configuration, the UE 715 may transmit a completion message to the network 710 (e.g., the serving cell 905), indicating that the UE 715 has received the measurement gap configuration. In some cases, the UE 715 may not request an indication of the measurement gap configuration and may instead perform receive and perform measurements using the PRSs during durations of inactivity experienced at the UE 715.

As shown in the process 900, the UE 715 may receive the PRSs from the TRPs 725 of the network 705 and perform measurements using the PRSs (block 960). The UE 715 may receive the PRSs during the measurement gaps indicated in the measurement gap configuration. For example, the UE 715 may use the stored indication of the measurement gap configuration to determine when the measurement gaps of the serving cell 905 or the network 710 will be, and the UE 715 may receive the PRSs from the TRPs 725 of the network 705 during the measurement gaps. In some cases, to receive the PRSs, the UE 715 may search for the PRSs from the TRPs 725 of the network 705 based on the assistance data received at block 945. That is, the assistance data may indicate which TRPs 725 of the network 705 to use for receiving the PRSs and a configuration of the PRSs from the TRPs 725 of the network 705. The UE 715 may use the assistance data to search for the PRSs from the TRPs 725 of the network 705 at a frequency, timing, and periodicity indicated by the assistance data.

In some cases, the UE 715 may tune to a frequency band associated with the network 705 based on the assistance data indicating the frequency band. In some such cases, the UE 715 may receive the PRSs using the frequency band. In some cases, to receive the PRSs or after receiving the PRSs, the UE 715 may synchronize with the network 705. For example, the UE 715 may perform a synchronization operation (e.g., using a signal synchronization block (SSB)) with the TRPs 725 of the network 705 associated with transmitting the PRSs. In some examples, the PRSs may be broadcast to the UE 715 using a broadcast channel associated with the network 705.

After receiving the PRSs from the TRPs 725 of the network 705, the UE 715 may use the PRSs to perform measurements for determining location data associated with the UE 715. That is, the UE 715 may use (e.g., compare) the PRSs to perform measurements, the results of which may be used to determine the location data associated with the UE 715. In some cases, the UE 715 may perform the measurements using the PRSs during the measurement gaps. In some examples, after performing the measurements, the UE 715 may transmit an indication to the serving cell 905 or the network 710 (e.g., the TRPs 725) that the measurements have been completed.

In some cases, performing the measurements may include determining the barometric pressure at the UE 715. For example, the barometric sensor (e.g., the barometric sensor 750) of the UE 715 may determine the barometric pressure based on an altitude of the UE 715.

As shown in the process 900, the UE 715 may transmit location data to the centralized platform 720 (block 965). In some cases, the location data may be the location data (e.g., PRS measurements) determined at block 960 as a result of performing the measurements. That is, the location data may be the raw information or measurement reporting associated with the PRSs received from the TRPs 725 of the network 705. In other cases, the location data may be an indication of the location of the UE 715. For example, the UE 715 may be configured to determine the location (e.g., an exact location) of the UE based on the location data determined at block 960. In some examples, the UE 715 may transmit the location data as the location data (e.g., PRS measurements) determined at block 960 based on the centralized platform 720 indicating to transmit the location data accordingly in the location data request received at block 950. However, in other examples, the UE 715 may transmit the location data as the indication of the location based on the centralized platform 720 indicating to transmit the location accordingly in the location data request received at block 850. In some examples, the location data may also include the barometric pressure of the UE 715.

As shown in process 900, the centralized platform 720 may transmit the location of the UE 715 to the third party 740 (block 970). In some cases, if the UE 715 transmitted the location data as the indication of location of the UE 715, the centralized platform 720 may forward the indication of the location from the UE 715 to the third party 740. In other cases, if the UE 715 transmitted the location data as the location data (e.g., PRS measurements) determined at block 960, the centralized platform 720 may determine the location of the UE 715 using the location data, and transmit an indication of the location to the third party 740. That is, if the UE 715 is configured to determine the location from the PRSs, the UE 715 may transmit the location to the centralized platform 720, and the centralized platform 720 may transmit the location to the third party 740. However, if the UE 715 is not configured to determine the location from the PRSs, the UE 715 may transmit the location data (e.g., PRS measurements) to the centralized platform 720, and the centralized platform 720 may use the location data to determine the location of the UE 715; then, the centralized platform 720 may transmit the location to the third party 740.

In some cases, determining the location of the UE 715 may include determining an altitude of the UE 715. For example, the centralized platform 720 may compare altitude measurements (e.g., altitude readings, barometric pressures) received from one or more altitude stations to the barometric pressure received from the UE 715 to determine an altitude of the UE 715. Thus, the location of the UE 715 transmitted to the third party 740 may include a location of the UE 715 relative to a geographical plane and an altitude.

In accordance with examples as described herein, the process 900 may support the network 705 providing positioning services to the UE 715 registered to the network 710, based on the centralized platform 720 facilitating operations between the network 705, the network 710, and the UE 715. The process 900 illustrates operations associated with supporting terrestrial PNT as described herein. Additionally, the process 900 includes operations associated with supporting three-dimensional location determination. Implementing the process 900 may enable improved accuracy and resiliency for determining the location of a UE 715.

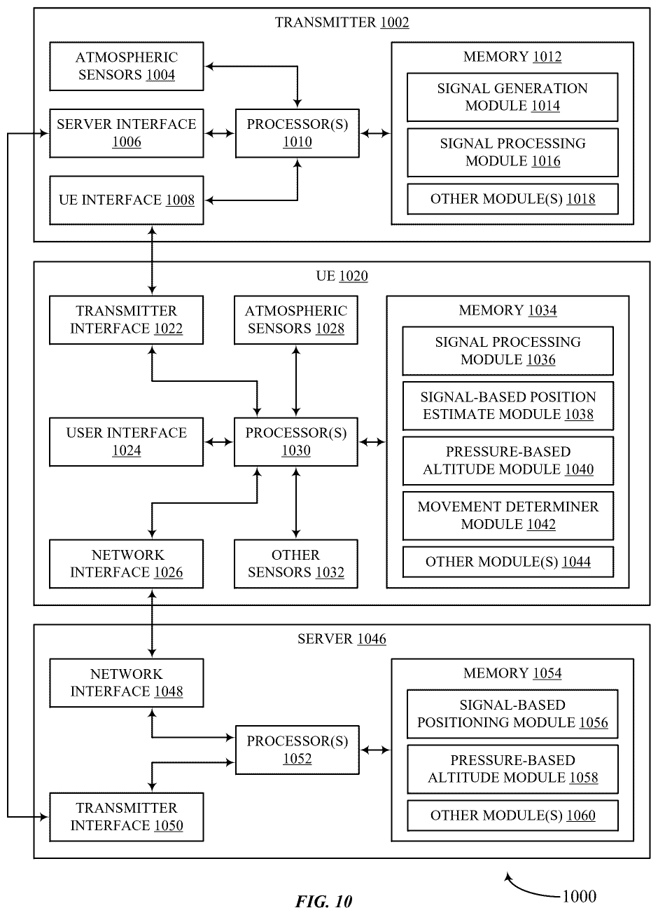

FIG. 10 illustrates an example device diagram 1000 including a transmitter 1002, a UE 1020, and a server 1046, in accordance with one or more implementations described herein. The transmitter 1002 may be an example of a network entity 110 (e.g., a base station, a node, a TRP) as described with reference to FIG. 1, or a TRP 725 as described with reference to FIG. 7. The UE 1020 may be an example of a UE 120 (e.g., a mobile device, a wireless device) as described with reference to FIG. 1, or a UE 715 as described with reference to FIG. 7. The server 1046 may be an example of a centralized platform 130 as described with reference to FIG. 1, or a centralized platform 720 as described with reference to FIG. 7.

By way of example in FIG. 10, transmitter 1002 (e.g., any transmitter such terrestrial PNT beacons, among others) discussed herein may include: a UE interface 1008 for exchanging information with the UE 1020 (or a UE timing receiver) (e.g., antenna(s) and RF front end components known in the art or otherwise disclosed herein); one or more processor(s) 1010 which may include one or more controllers for facilitating operations of the transmitter 1002; a memory 1012 (e.g., a data storage component) coupled to the one or more processors 1010 for providing storage and retrieval of information and/or program instructions; atmospheric sensor(s) 1004 (e.g., altitude stations 140, altitude stations 735) for measuring environmental conditions (e.g., pressure, temperature, humidity, other) at or near the transmitter 1002; a server interface 1006 for exchanging information with the server 1046 (e.g., a receiver assistance server(s), a TWTT server) (e.g., an antenna, a network interface, or other); and any other components known to one of ordinary skill in the art. The memory 1012 may include memory storing data and software modules with executable instructions, including a signal generation module 1014, a signal processing module 1016, and other modules 1018.

The memory 1012 may include memory storing software modules with executable instructions, and the one or more processor(s) 1010 may perform different actions by executing the instructions from the modules, including: (i) performance of part or all of the methods as described herein or otherwise understood by one of skill in the art as being performable at the transmitter 1002; (ii) generation of positioning signals for transmission using a selected time, frequency, code, and/or phase (e.g., associated with the signal generation module 1014); (iii) processing of signaling received from the UE 1020, the server 1046, or another source (e.g., associated with the signal processing module 1016); or (iv) other processing as required by operations described in this disclosure (e.g., associated with the other modules 1018). Steps performed by the transmitter 1002 as described herein may also be performed on other machines that are remote from the transmitter 1002, including the UE 1020, the server 1046, computers of enterprises, or any other suitable machine. Signals generated and transmitted by the transmitter 1002 may carry different information that, once determined by the UE 1020 or the server 1046, may identify the following: the transmitter 1002; the transmitter's position; environmental conditions at or near the transmitter 1002; the UE 1020; the UE's position; environmental conditions at or near the UE 1020; and/or other information known in the art. The atmospheric sensor(s) 1004 may be integral with the transmitter 1002 or separate from the transmitter 1002, and/or co-located with the transmitter 1002 or located in the vicinity of the transmitter 1002 (e.g., within a threshold amount of distance).

By way of example in FIG. 10, the UE 1020 may include a network interface 1026 for exchanging information with the server 1046 via a network (e.g., a network 100, a network 600, a network 705, a network 710) (e.g., a wired and/or a wireless interface port, an antenna, and RF front end components known in the art or otherwise disclosed herein); one or more processor(s) 1030 (e.g., a positioning controller 745) which may include one or more controllers for facilitating operations of the UE 1020; a memory 1034 (e.g., a data storage component) for providing storage and retrieval of information and/or program instructions; atmospheric sensor(s) 1028 (e.g., a barometric sensor 750) for measuring environmental conditions (e.g., pressure, temperature, other) at the UE 1020; other sensor(s) 1032 for measuring other conditions (e.g., compass, accelerometer and inertial sensors for measuring movement and orientation); a user interface 924 (e.g., display, keyboard, microphone, speaker, other) for permitting the user of the UE 1020 to provide inputs and receive outputs; a transmitter interface 1022 for exchanging information with the transmitter 1002 (e.g., a wired and/or wireless interface port, an antenna, and RF front end components known in the art or otherwise disclosed herein); and any other components known to one of ordinary skill in the art. A GNSS interface and processing unit (not shown) are contemplated, which may be integrated with other components or a stand-alone antenna, RF front end, and processors dedicated to receiving and processing GNSS signaling. The memory 1034 may include memory storing data and software modules with executable instructions, including a signal processing module 1036, a signal-based position estimate module 1038, a pressure-based altitude module 1040, a movement determination module 1042, a data packet, and other modules 1044.

The processor(s) 1030 may perform different actions by executing the instructions from the modules, including: (i) performance of part or all of the methods, processes and techniques as described herein or otherwise understood by one of ordinary skill in the art as being performable at the UE 1020; (ii) processing of signaling received from the transmitter 1002, the server 1046, or another source (e.g., associated with the signal processing module 1036); (iii) estimation of an altitude of the UE 1020 (e.g., associated with the pressure-based altitude module 1040); (iv) computation of an estimated position of the UE 1020 (e.g., associated with the signal-based position estimate module 1038); (v) determination of movement of the UE 1020 (e.g., associated with the movement determiner module 1042); (vi) performance of calibration techniques; (vii) calibration of the UE 1020; (viii) determination of calibration conduciveness for a calibration opportunity; or (ix) other processing as required by operations or processes described in this disclosure (e.g., associated with the other modules 1044). Steps performed by the UE 1020 as described herein may also be performed on other machines that are remote from the UE 1020, including the transmitter 1002, the server 1046, computers of enterprises, or any other suitable machine. Signals generated and transmitted by the UE 1020 may carry different information that, once determined by the transmitter 1002 or the server 1046, may identify the following: the UE 1020; the UE's position; environmental conditions at or near the UE 1020; the transmitter 1002; the transmitter's position; environmental conditions at or near the transmitter 1002; and/or other information known in the art.

By way of example in FIG. 10, the server 1046 may include: a network interface 1048 for exchanging information with the UE 1020 and other sources of data via the network (e.g., a wired and/or a wireless interface port, an antenna, or other); one or more processor(s) 1052 (e.g., a positioning controller 730) which may include one or more controllers for facilitating operations of the server 1046; a memory 1054 (e.g., a data storage component) for providing storage and retrieval of information and/or program instructions; a transmitter interface 1050 for exchanging information with the transmitter 1002 and other sources of data via the network (e.g., a wired and/or a wireless interface port, an antenna, or other); and any other components known to one of ordinary skill in the art. The memory 1054 may include memory storing software modules with executable instructions, including a signal-based positioning module 1056, a pressure-based altitude module 1058, as well as other modules 1060 for each of the above-described methods and processes or portions/steps thereof.

The processor(s) 1052 may perform different actions by executing instructions from the modules, including: (i) performance of part or all of the methods, processes, and techniques as described herein or otherwise understood by one of ordinary skill in the art as being performable at the server 1046; (ii) processing of signaling received from the transmitter 1002, the UE 1020, or another source (e.g., associated with the signal processing module 1056); (iii) estimation of an altitude of the UE 1020 (e.g., associated with the pressure-based altitude module 1058); (iv) computation of an estimated position of the UE 1020; or (v) other processing as required by operations or processes described in this disclosure (e.g., associated with the other modules 1060). Steps performed by the server 1046 as described herein may also be performed on other machines that are remote from the server 1046, including the transmitter 1002, the UE 1020, computers of enterprises, or any other suitable machine. Signals generated and transmitted by the server 1046 may carry different information that, once determined by the transmitter 1002 or the UE 1020, may identify the following: the UE 1020; the UE's position; environmental conditions at or near the UE 1020; the transmitter 1002; the transmitter's position; environmental conditions at or near the transmitter 1002; and/or other information known in the art.

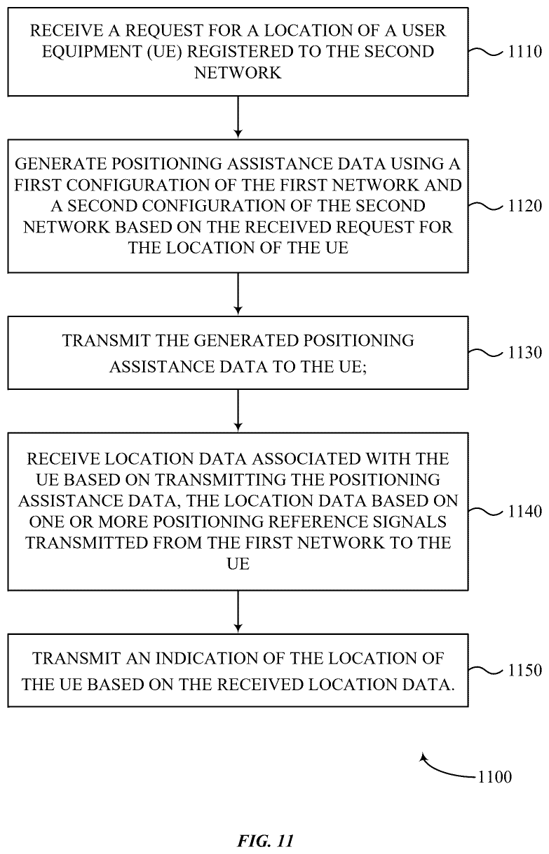

FIG. 11 illustrates an example of a process 1100 that supports open PNT access to a cellular network supporting accurate and resilient PNT services in accordance with one or more implementations described herein. The process 1100 may be implemented by a network (e.g., a network 100, a network 600, a network 705, a network 710), a network entity (e.g., a network entity 110), a centralized platform (e.g., a centralized platform 130, a centralized platform 720), a UE (e.g., a UE 120, a UE 715), or one or more other systems or devices, or any combination thereof. That is, the process 1100 may be implemented by one or more devices as described with reference to FIGS. 1, 6, and 7.

In some cases, the process 1100 may illustrate operations, processes, or aspects of devices described herein, including the devices as described with reference to FIG. 10. In some examples, the process 1100 may include one or more other operations not illustrated in FIG. 11; one or more operations in a different order than illustrated by FIG. 11; or one or more fewer operations than illustrated in FIG. 11, or any combination thereof. Additionally, or alternatively, the process 1100 may implement one or more operations in which the one or more operations are performed at least partially independently, sequentially, or concurrently, or any combination thereof with reference to a location, device, or time of each of the one or more operations. As such, the process 1100 may be indicative of techniques not limited by the number, sequence, arrangement, timing, etc., of the operations illustrated in FIG. 11.

The process 1100 may be implemented at a computing device configured to communicate with a first network operable to provide positioning services and a second network, different from the first network. The process 1100 may include receiving a request for a location of a user equipment (UE) registered to the second network (block 1110). The process 1100 may include, in response to receiving the request for the location of the UE: generating positioning assistance data using a first configuration of the first network and a second configuration of the second network based on the received request for the location of the UE (block 1120); transmitting the generated positioning assistance data to the UE (block 1130); receiving location data associated with the UE based on transmitting the positioning assistance data, the location data based on one or more positioning reference signals transmitted from the first network to the UE (block 1140); and transmitting an indication of the location of the UE based on the received location data (1150).

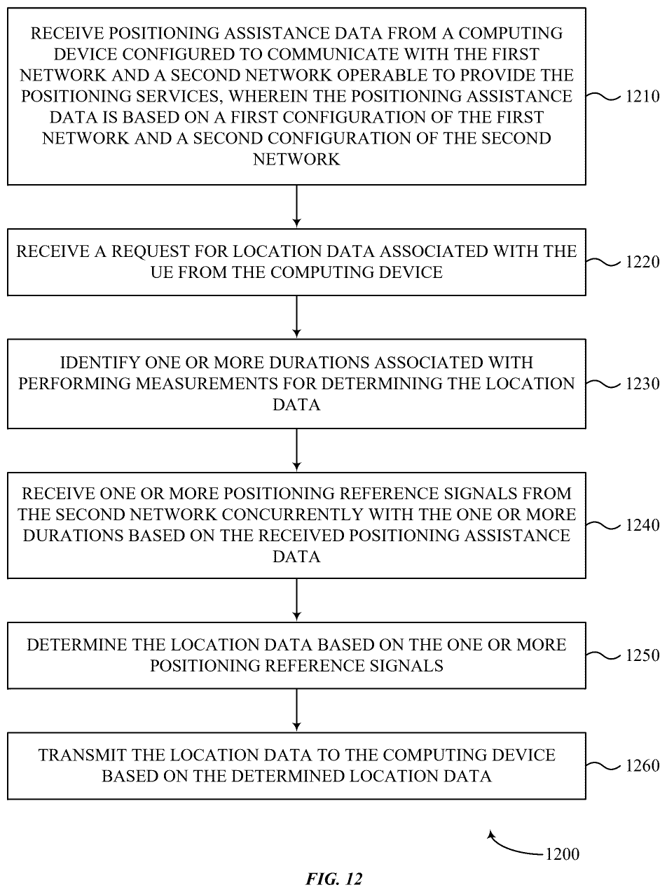

FIG. 12 illustrates an example of a process 1200 that supports open PNT access to a cellular network supporting accurate and resilient PNT services in accordance with one or more implementations described herein. The process 1200 may be implemented by a network (e.g., a network 100, a network 600, a network 705, a network 710), a network entity (e.g., a network entity 110), a centralized platform (e.g., a centralized platform 130, a centralized platform 720), a UE (e.g., a UE 120, a UE 715), or one or more other systems or devices, or any combination thereof. That is, the process 1200 may be implemented by one or more devices as described with reference to FIGS. 1, 6, and 7.

In some cases, the process 1200 may illustrate operations, processes, or aspects of devices described herein, including the devices as described with reference to FIG. 10. In some examples, the process 1200 may include one or more other operations not illustrated in FIG. 12; one or more operations in a different order than illustrated by FIG. 12; or one or more fewer operations than illustrated in FIG. 12, or any combination thereof. Additionally, or alternatively, the process 1200 may implement one or more operations in which the one or more operations are performed at least partially independently, sequentially, or concurrently, or any combination thereof with reference to a location, device, or time of each of the one or more operations. As such, the process 1200 may be indicative of techniques not limited by the number, sequence, arrangement, timing, etc., of the operations illustrated in FIG. 12.

The process 1200 may be implemented at a user equipment (UE) registered to a first network inoperable to provide positioning services. The process 1200 may include receiving positioning assistance data from a computing device configured to communicate with the first network and a second network operable to provide the positioning services, wherein the positioning assistance data is based on a first configuration of the first network and a second configuration of the second network (block 1210). The process 1200 may include receiving a request for location data associated with the UE from the computing device (block 1220). The process 1200 may include, in response to receiving the request for the location data: identifying one or more durations associated with performing measurements for determining the location data (block 1230); receiving one or more positioning reference signals from the second network concurrently with the one or more durations based on the received positioning assistance data (block 1240); determining the location data based on the one or more positioning reference signals (block 1250); and transmitting the location data to the computing device based on the determined location data (block 1260).

Examples and/or embodiments described herein may include subject matter which may be implemented as a method, means for performing acts (e.g., operations, processes) or blocks of the method, at least one machine-readable medium including executable instructions that, when performed by a machine (e.g., one or more processors, one or more controllers, etc.) with memory, (e.g., an application-specific integrated circuit (ASIC), a field programmable gate array (FPGA), or the like) cause the machine to perform acts of the method or of an apparatus or system for concurrent communication using multiple communication technologies according to embodiments and examples described.

In example 1, which may also include one or more of the examples described herein, a method, may include, at a computing device configured to communicate with a first network operable to provide positioning services and a second network, different from the first network, receiving a request for a location of a user equipment (UE) registered to the second network; and in response to receiving the request for the location of the UE: generating positioning assistance data using a first configuration of the first network and a second configuration of the second network based on the received request for the location of the UE; transmitting the generated positioning assistance data to the UE; receiving location data associated with the UE based on transmitting the positioning assistance data, the location data based on one or more positioning reference signals transmitted from the first network to the UE; and transmitting an indication of the location of the UE based on the received location data.

In example 2, which may also include one or more of the examples described herein, the generated positioning assistance data is based on: first configuration information received from the first network indicating the first configuration, where the first configuration information may include a configuration of one or more transmitters of the first network that transmit the one or more positioning reference signals; and second configuration information received from the second network indicating the second configuration, where the second configuration information may include a configuration of one or more cells associated with the UE and supported by the second network.

In example 3, which may also include one or more of the examples described herein, generating the position assistance data may include: mapping the one or more cells to the one or more transmitters based on the first configuration information and the second configuration information; and identifying at least one transmitter of the one or more transmitters associated with the one or more cells.

In example 4, which may also include one or more of the examples described herein, generating the position assistance data may further include: receiving a coarse positioning estimate of the UE from the second network, where identifying the at least one transmitter of the one or more transmitters is based on receiving the coarse positioning estimate of the UE.

In example 5, which may also include one or more of the examples described herein, the method may include: registering the UE to communicate with the computing device, where receiving the request for the location of the UE is based on registering the UE to communicate with the computing device.

In example 6, which may also include one or more of the examples described herein, generating the position assistance data is based on: authenticating the request for the location of the UE to determine a validity of the request; and authorizing the request for the location of the UE based on the determined validity of the request.

In example 7, which may also include one or more of the examples described herein, generating the position assistance data may further include: requesting positioning capabilities supported by the UE; and receiving the positioning capabilities supported by the UE, where generating the positioning assistance data is based on the received positioning capabilities supported by the UE.

In example 8, which may also include one or more of the examples described herein, the method may further include: receiving a request for the positioning assistance data from the UE, where generating and transmitting the positioning assistance data is based on receiving the request for the positioning assistance data.

In example 9, which may also include one or more of the examples described herein, the received location data associated with the UE is received in response to a request by the computing device for the location data from the UE.

In example 10, which may also include one or more of the examples described herein, the method may further include: receiving a second request for a location of a second UE registered to the first network; and in response to receiving the second request for the location of the second UE: generating second positioning assistance data using the first configuration of the first network based on the received second request for the location of the second UE; transmitting the generated second positioning assistance data to the second UE; receiving second location data associated with the second UE based on transmitting the second positioning assistance data, the second location data based on one or more positioning reference signals transmitted from the first network to the second UE; and transmitting a second indication of the location of the second UE based on the received second location data.

In example 11, which may also include one or more of the examples described herein, transmitting the generated second positioning assistance data is based on using a control plane or a data plane associated with the first network.

In example 12, which may also include one or more of the examples described herein, transmitting the generated positioning assistance data is based on using an over-the-top data transmission.

In example 13, which may also include one or more of the examples described herein, the location data may include the indication of the location of the UE.

In example 14, which may also include one or more of the examples described herein, the method may further include: determining the location of the UE using the received location data, where transmitting the indication of the location of the UE is based on the determined location of the UE.

In example 15, which may also include one or more of the examples described herein, the method may further include: determining a timing offset between the first network and the second network; and transmitting an indication of the timing offset to the UE.

In example 16, which may also include one or more of the examples described herein, the UE is not registered to the first network.

In example 17, which may also include one or more of the examples described herein, the request for the location of the UE is received from an application or a third party, and the indication of the location of the UE is transmitted to the application or the third party.

In example 18, which may also include one or more of the examples described herein, the method may further include: receiving a plurality of reference altitudes from a plurality of altitude stations communicatively coupled with the computing device; receiving an indication of a barometric pressure associated with the UE; converting the barometric pressure into an altitude measurement of the UE based on comparing the indication of the barometric pressure to the plurality of reference altitudes; and determining the location of the UE based on the altitude measurement of the UE and the location data, where the transmitted indication of the location of the UE is based on the determined location of the UE.

In example 19, which may also include one or more of the examples described herein, a method, may include, at a user equipment (UE) registered to a first network inoperable to provide positioning services: receiving positioning assistance data from a computing device configured to communicate with the first network and a second network operable to provide the positioning services, where the positioning assistance data is based on a first configuration of the first network and a second configuration of the second network; receiving a request for location data associated with the UE from the computing device; and in response to receiving the request for the location data: identifying one or more durations associated with performing measurements for determining the location data; receiving one or more positioning reference signals from the second network concurrently with the one or more durations based on the received positioning assistance data; determining the location data based on the one or more positioning reference signals; and transmitting the location data to the computing device based on the determined location data.

In example 20, which may also include one or more of the examples described herein, the positioning assistance data is based on: first configuration information indicating the first configuration and may include a configuration of one or more cells associated with the UE and supported by the first network; and second configuration information indicating the second configuration and may include a configuration of one or more transmitters of the second network that transmit the one or more positioning reference signals.

In example 21, which may also include one or more of the examples described herein, the positioning assistance data may include an indication of at least one transmitter of the one or more transmitters that correlates to the one or more cells.

In example 22, which may also include one or more of the examples described herein, the method may further include: registering the UE to communicate with the computing device, where receiving the positioning assistance data is based on registering the UE to communicate with the computing device.

In example 23, which may also include one or more of the examples described herein, the method may further include: receiving a request for positioning capabilities supported by the UE; in response to receiving the request for the positioning capabilities supported by the UE: transmitting the positioning capabilities supported by the UE to the computing device, where receiving the positioning assistance data is based on the transmitted positioning capabilities.

In example 24, which may also include one or more of the examples described herein, the method may further include: transmitting a request for the positioning assistance data, where receiving the positioning assistance data is based on the transmitted request for the positioning assistance data.

In example 25, which may also include one or more of the examples described herein, identifying the one or more durations may include: requesting an indication of the one or more durations from the first network; and in response to requesting the indication of the one or more durations: receiving the indication of the one or more durations from the first network; and transmitting a completion message associated with the identified one or more durations.

In example 26, which may also include one or more of the examples described herein, determining the location data may include: measuring the one or more positioning reference signals received from one or more transmitters supported by the second network based on the positioning assistance data indicating a configuration of the one or more positioning reference signals and the one or more transmitters.

In example 27, which may also include one or more of the examples described herein, the method may further include: transmitting an indication that the UE has completed determining the location data, where transmitting the location data is based on the transmitted indication.

In example 28, which may also include one or more of the examples described herein, the method may further include: syncing the UE to the second network based on receiving the one or more positioning reference signals.

In example 29, which may also include one or more of the examples described herein, the location data may include an indication of a location of the UE, and where determining the location data may include determining the indication of the location of the UE.

In example 30, which may also include one or more of the examples described herein, the location data may include one or more positioning reference signal measurements.

In example 31, which may also include one or more of the examples described herein, the method may further include: receiving an indication of a timing offset between the first network and the second network from the computing device, where receiving the one or more positioning reference signals is based on the received indication of the timing offset.

In example 32, which may also include one or more of the examples described herein, the method may further include: determining a first timing or first frequency of the first network; and determining a second timing or second frequency of the second network based on the determined first timing or the first frequency, where receiving the positioning reference signaling is based on the determined second timing or the second frequency.

In example 33, which may also include one or more of the examples described herein, the method may further include: identifying a barometric pressure associated with the UE; and transmitting the barometric pressure to the computing device, where the location data and the barometric pressure are associated with a location of the UE.

Reference has been made in detail to embodiments of the disclosed invention. Each example has been provided by way of an explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only and is not intended to limit the invention.

The examples discussed above also extend to method, computer-readable medium, and means-plus-function claims and implementations, any of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art may recognize.

In this regard, while the disclosed subject matter has been described in connection with various examples, implementations, aspects, etc., and corresponding Figures, where applicable, it is to be understood that other similar aspects may be used or modifications and additions may be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct, or they may be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed:

1. A method, comprising:
at a computing device configured to communicate with a first network operable to provide positioning services and a second network, different from the first network:
receiving a request for a location of a user equipment (UE) registered to the second network; and
in response to receiving the request for the location of the UE:
generating positioning assistance data using a first configuration of the first network and a second configuration of the second network based on the received request for the location of the UE;
transmitting the generated positioning assistance data to the UE;
receiving location data associated with the UE based on transmitting the positioning assistance data, the location data based on one or more positioning reference signals transmitted from the first network to the UE; and
transmitting an indication of the location of the UE based on the received location data.

2. The method of claim 1, wherein the generated positioning assistance data is based on:
first configuration information received from the first network indicating the first configuration, wherein the first configuration information comprises a configuration of one or more transmitters of the first network that transmit the one or more positioning reference signals; and
second configuration information received from the second network indicating the second configuration, wherein the second configuration information comprises a configuration of one or more cells associated with the UE and supported by the second network.

3. The method of claim 2, wherein generating the position assistance data comprises
mapping the one or more cells to the one or more transmitters based on the first configuration information and the second configuration information; and
identifying at least one transmitter of the one or more transmitters associated with the one or more cells.

4. The method of claim 3, wherein generating the position assistance data further comprises:
receiving a coarse positioning estimate of the UE from the second network,
wherein identifying the at least one transmitter of the one or more transmitters is based on receiving the coarse positioning estimate of the UE.

5. The method of claim 1, further comprising:
registering the UE to communicate with the computing device,
wherein receiving the request for the location of the UE is based on registering the UE to communicate with the computing device.

6. The method of claim 1, wherein generating the position assistance data is based on:
authenticating the request for the location of the UE to determine a validity of the request; and
authorizing the request for the location of the UE based on the determined validity of the request.

7. The method of claim 1, wherein generating the position assistance data further comprises:
requesting positioning capabilities supported by the UE; and
receiving the positioning capabilities supported by the UE,
wherein generating the positioning assistance data is based on the received positioning capabilities supported by the UE.

8. The method of claim 1, further comprising:
receiving a request for the positioning assistance data from the UE,
wherein generating and transmitting the positioning assistance data is based on receiving the request for the positioning assistance data.

9. The method of claim 1, wherein the received location data associated with the UE is received in response to a request by the computing device for the location data from the UE.

10. The method of claim 1, further comprising:
receiving a second request for a location of a second UE registered to the first network; and
in response to receiving the second request for the location of the second UE:
generating second positioning assistance data using the first configuration of the first network based on the received second request for the location of the second UE;
transmitting the generated second positioning assistance data to the second UE;
receiving second location data associated with the second UE based on transmitting the second positioning assistance data, the second location data based on one or more positioning reference signals transmitted from the first network to the second UE; and
transmitting a second indication of the location of the second UE based on the received second location data.

11. The method of claim 10, wherein transmitting the generated second positioning assistance data is based on using a control plane or a data plane.

12. The method of claim 1, wherein transmitting the generated positioning assistance data is based on using an over-the-top data transmission.

13. The method of claim 1, wherein the location data comprises the indication of the location of the UE.

14. The method of claim 1, further comprising:
determining the location of the UE using the received location data,
wherein transmitting the indication of the location of the UE is based on the determined location of the UE.

15. The method of claim 1, further comprising:
determining a timing offset between the first network and the second network; and
transmitting an indication of the timing offset to the UE.

16. The method of claim 1, wherein the UE is not registered to the first network.

17. The method of claim 1, wherein the request for the location of the UE is received from an application or a third party, and the indication of the location of the UE is transmitted to the application or the third party.

18. The method of claim 1, further comprising:
receiving a plurality of reference altitudes from a plurality of altitude stations communicatively coupled with the computing device;
receiving an indication of a barometric pressure associated with the UE;
converting the barometric pressure into an altitude measurement of the UE based on comparing the indication of the barometric pressure to the plurality of reference altitudes; and
determining the location of the UE based on the altitude measurement of the UE and the location data,
wherein the transmitted indication of the location of the UE is based on the determined location of the UE.

19. A method, comprising:
at a user equipment (UE) registered to a first network inoperable to provide positioning services:
receiving positioning assistance data from a computing device configured to communicate with the first network and a second network operable to provide the positioning services, wherein the positioning assistance data is based on a first configuration of the first network and a second configuration of the second network;
receiving a request for location data associated with the UE from the computing device; and
in response to receiving the request for the location data:
identifying one or more durations associated with performing measurements for determining the location data;
receiving one or more positioning reference signals from the second network concurrently with the one or more durations based on the received positioning assistance data;
determining the location data based on the one or more positioning reference signals; and
transmitting the location data to the computing device based on the determined location data.

20. The method of claim 17, wherein the positioning assistance data is based on:
first configuration information indicating the first configuration and comprising a configuration of one or more cells associated with the UE and supported by the first network; and
second configuration information indicating the second configuration and comprising a configuration of one or more transmitters of the second network that transmit the one or more positioning reference signals.
